(19) United States
(12) Patent Application Publication
(10) Pub. No.: US 2024/0107443 A1
(43) Pub. Date: Mar. 28, 2024

(54) METHODS AND DEVICES TO DETERMINE AN ANTENNA CONFIGURATION FOR AN ANTENNA ARRAY

(71) Applicant: Intel Corporation, Santa Clara, CA (US)

(72) Inventors: Vaibhav SINGH, New Delhi (IN); Christian MACIOCCO, Portland, OR (US)

(21) Appl. No.: 17/953,361

(22) Filed: Sep. 27, 2022

(51) Int. Cl. H04W 52/02; H04B 7/0413; H04B 7/06; H04B 7/08

(52) U.S. Cl. CPC H04W 52/0206; H04B 7/0413; H04B 7/06; H04B 7/08

(57) ABSTRACT

A device may include a memory and a processor configured to determine, based on first cell data representative of conditions of a cell of a mobile communication network at a first stage associated with a first instance of time, a set of configurations for an antenna array comprising a plurality of antenna elements, wherein each configuration of the set of configurations comprises a configuration in which a subset of the plurality of antenna elements are to be used to perform communications within the cell, and select one or more antenna configurations for the antenna array from the determined set of configurations, wherein each antenna configuration of the one or more antenna configurations are selected based on further cell data representative of the conditions of the cell at a further stage associated with a further instance of time after the first instance of time.

### TECHNICAL FIELD

This disclosure generally relates to methods and devices for the determination of an antenna configuration for an antenna array.

### BACKGROUND

In mobile radio communication networks in accordance with many mobile radio communication technologies, such as Fourth Generation (LTE) and Fifth Generation (5G) New Radio (NR), communication devices, such as network access nodes, may include one or more antenna arrays including a plurality of antenna elements to increase gain and directivity of radiation. Furthermore, with the adoption of multiple-input, multiple-output (MIMO), multi-user MIMO, and massive MIMO technologies, radio access networks employ antenna arrays to increase spectral efficiency.

The increasing number of antenna elements in antenna arrays may proportionally increase the power consumption of radio communication devices including such arrays since a considerable amount of power may be required to perform radio frequency (RF) operations in order to transmit and receive radio communication signals via the antenna elements. On the other hand, desired radio communication performance from a radio communication device may vary based on cell conditions. It may be desirable to reduce the power consumed by RF operations associated with an antenna array of a radio communication device.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosure. In the following description, various aspects of the disclosure are described with reference to the following drawings, in which:

FIG. 1 shows an exemplary radio communication network;

FIG. 2 shows an exemplary internal configuration of a communication device;

FIG. 3A illustrates a simplified digital baseband beamforming architecture that digitally applies complex beamforming weights;

FIG. 3B shows an RF beamforming approach;

FIG. 4 shows an exemplary illustration of two cells of a mobile communication network;

FIG. 5 shows an example of different antenna configurations of a grid antenna array;

FIG. 6 shows an exemplary illustration of various communication elements of a communication device;

FIG. 7 shows an example of a procedure to select an antenna configuration;

FIG. 8 shows an example of a device;

FIG. 9 shows an exemplary procedure to select an antenna configuration;

FIG. 10 shows an exemplary illustration of antenna configurations according to the selection procedure;

FIG. 11 shows an example of a processor and a memory of a device;

FIG. 12 shows an example of a trained AI/ML;

FIG. 13 shows an example illustration of performance metric predictions;

FIG. 14 shows an exemplary representation of a reinforcement learning model based AI/ML;

FIG. 15 shows an exemplary illustration of various entities of a mobile communication network;

FIG. 16 shows an exemplary radio access network architecture in which the radio access network is disaggregated in multiple units;

FIG. 17 shows an example of a method.

### DESCRIPTION

The following detailed description refers to the accompanying drawings that show, by way of illustration, exemplary details and aspects in which aspects of the present disclosure may be practiced.

The word “exemplary” is used herein to mean “serving as an example, instance, or illustration”. Any embodiment or design described herein as “exemplary” is not necessarily to be construed as preferred or advantageous over other embodiments or designs.

The words “plurality” and “multiple” in the description or the claims expressly refer to a quantity greater than one. The terms “group (of)”, “set [of]”, “collection (of)”, “series (of)”, “sequence (of)”, “grouping (of)”, etc., and the like in the description or in the claims refer to a quantity equal to or greater than one, i.e. one or more. Any term expressed in a plural form that does not expressly state “plurality” or “multiple” likewise refers to a quantity equal to or greater than one.

Any vector and/or matrix notation utilized herein is exemplary in nature and is employed solely for purposes of explanation. Accordingly, the apparatuses and methods of this disclosure accompanied by vector and/or matrix notation are not limited to being implemented solely using vectors and/or matrices, and the associated processes and computations may be equivalently performed with respect to sets, sequences, groups, etc., of data, observations, information, signals, samples, symbols, elements, etc.

As used herein, “memory” is understood as a non-transitory computer-readable medium in which data or information can be stored for retrieval. References to “memory” included herein may thus be understood as referring to volatile or non-volatile memory, including random access memory (“RAM”), read-only memory (“ROM”), flash memory, solid-state storage, magnetic tape, hard disk drive, optical drive, etc., or any combination thereof. Furthermore, registers, shift registers, processor registers, data buffers, etc., are also embraced herein by the term memory. A single component referred to as “memory” or “a memory” may be composed of more than one different type of memory, and thus may refer to a collective component including one or more types of memory. Any single memory component may be separated into multiple collectively equivalent memory components, and vice versa. Furthermore, while memory may be depicted as separate from one or more other components (such as in the drawings), memory may also be integrated with other components, such as on a common integrated chip or a controller with an embedded memory.

The term “software” refers to any type of executable instruction, including firmware.

In the context of this disclosure, the term “process” may be used, for example, to indicate a method. Illustratively, any process described herein may be implemented as a method (e.g., a channel estimation process may be understood as a channel estimation method). Any process described herein may be implemented as a non-transitory computer readable medium including instructions configured, when executed, to cause one or more processors to carry out the process (e.g., to carry out the method).

The apparatuses and methods of this disclosure may utilize or be related to radio communication technologies. While some examples may refer to specific radio communication technologies, the examples provided herein may be similarly applied to various other radio communication technologies, both existing and not yet formulated, particularly in cases where such radio communication technologies share similar features as disclosed regarding the following examples. Various exemplary radio communication technologies that the apparatuses and methods described herein may utilize include, but are not limited to: a Global System for Mobile Communications (“GSM”) radio communication technology, a General Packet Radio Service (“GPRS”) radio communication technology, an Enhanced Data Rates for GSM Evolution (“EDGE”) radio communication technology, and/or a Third Generation Partnership Project (“3GPP”) radio communication technology, for example Universal Mobile Telecommunications System (“UMTS”), Freedom of Multimedia Access (“FOMA”), 3GPP Long Term Evolution (“LTE”), 3GPP Long Term Evolution Advanced (“LTE Advanced”), Code division multiple access 2000 (“CDMA2000”), Cellular Digital Packet Data (“CDPD”), Mobitex, Third Generation (3G), Circuit Switched Data (“CSD”), High-Speed Circuit-Switched Data (“HSCSD”), Universal Mobile Telecommunications System (“Third Generation”) (“UMTS (3G)”), Wideband Code Division Multiple Access (Universal Mobile Telecommunications System) (“W-CDMA (UMTS)”), High Speed Packet Access (“HSPA”), High-Speed Downlink Packet Access (“HSDPA”), High-Speed Uplink Packet Access (“HSUPA”), High Speed Packet Access Plus (“HSPA+”), Universal Mobile Telecommunications System-Time-Division Duplex (“UMTS-TDD”), Time Division-Code Division Multiple Access (“TD-CDMA”), Time Division-Synchronous Code Division Multiple Access (“TD-CDMA”), 3rd Generation Partnership Project Release 8 (Pre-4th Generation) (“3GPP Rel. 8 (Pre-4G)”), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17), 3GPP Rel. 18 (3rd Generation Partnership Project Release 18), 3GPP 5G, 3GPP LTE Extra, LTE-Advanced Pro, LTE Licensed-Assisted Access (“LAA”), MuLTEfire, UMTS Terrestrial Radio Access (“UTRA”), Evolved UMTS Terrestrial Radio Access (“E-UTRA”), Long Term Evolution Advanced (4th Generation) (“LTE Advanced (4G)”), cdmaOne (“2G”), Code division multiple access 2000 (Third generation) (“CDMA2000 (3G)”), Evolution-Data Optimized or Evolution-Data Only (“EV-DO”), Advanced Mobile Phone System (1st Generation) (“AMPS (1G)”), Total Access Communication arrangement/Extended Total Access Communication arrangement (“TACS/ETACS”), Digital AMPS (2nd Generation) (“D-AMPS (2G)”), Push-to-talk (“PTT”), Mobile Telephone System (“MTS”), Improved Mobile Telephone System (“IMTS”), Advanced Mobile Telephone System (“AMTS”), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (“Autotel/PALM”), ARP (Finnish for Autoradiopuhelin, “car radio phone”), NMT (Nordic Mobile Telephony), High capacity version of NTT (Nippon Telegraph and Telephone) (“Hicap”), Cellular Digital Packet Data (“CDPD”), Mobitex, DataTAC, Integrated Digital Enhanced Network (“iDEN”), Personal Digital Cellular (“PDC”), Circuit Switched Data (“CSD”), Personal Handy-phone System (“PHS”), Wideband Integrated Digital Enhanced Network (“WiDEN”), iBurst, Unlicensed Mobile Access (“UMA”), also referred to as also referred to as 3GPP Generic Access Network, or GAN standard), Zigbee, Bluetooth®, Wireless Gigabit Alliance (“WiGig”) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p and other) Vehicle-to-Vehicle (“V2V”) and Vehicle-to-X (“V2X”) and Vehicle-to-Infrastructure (“V2I”) and Infrastructure-to-Vehicle (“I2V”) communication technologies, 3GPP cellular V2X, DSRC (Dedicated Short Range Communications) communication arrangements such as Intelligent-Transport-Systems, and other existing, developing, or future radio communication technologies.

The apparatuses and methods described herein may use such radio communication technologies according to various spectrum management schemes, including, but not limited to, dedicated licensed spectrum, unlicensed spectrum, (licensed) shared spectrum (such as LSA=Licensed Shared Access in 2.3-2.4 GHz, 3.4-3.6 GHz, 3.6-3.8 GHz and further frequencies and SAS=Spectrum Access System in 3.55-3.7 GHz and further frequencies), and may use various spectrum bands including, but not limited to, IMT (International Mobile Telecommunications) spectrum (including 450-470 MHz, 790-960 MHz, 1710-2025 MHz, 2110-2200 MHz, 2300-2400 MHz, 2500-2690 MHz, 698-790 MHz, 610-790 MHz, 3400-3600 MHz, etc., where some bands may be limited to specific region(s) and/or countries), IMT-advanced spectrum, IMT-2020 spectrum (expected to include 3600-3800 MHz, 3.5 GHz bands, 700 MHz bands, bands within the 24.25-86 GHz range, etc.), spectrum made available under FCC's “Spectrum Frontier” 5G initiative (including 27.5-28.35 GHz, 29.1-29.25 GHz, 31-31.3 GHz, 37-38.6 GHz, 38.6-40 GHz, 42-42.5 GHz, 57-64 GHz, 64-71 GHz, 71-76 GHz, 81-86 GHz and 92-94 GHz, etc.), the ITS (Intelligent Transport Systems) band of 5.9 GHz (typically 5.85-5.925 GHz) and 63-64 GHz, bands currently allocated to WiGig such as WiGig Band 1 (57.24-59.40 GHz), WiGig Band 2 (59.40-61.56 GHz) and WiGig Band 3 (61.56-63.72 GHz) and WiGig Band 4 (63.72-65.88 GHz), the 70.2 GHz-71 GHz band, any band between 65.88 GHz and 71 GHz, bands currently allocated to automotive radar applications such as 76-81 GHz, and future bands including 94-300 GHz and above. Furthermore, the apparatuses and methods described herein can also employ radio communication technologies on a secondary basis on bands such as the TV White Space bands (typically below 790 MHz) where e.g. the 400 MHz and 700 MHz bands are prospective candidates. Besides cellular applications, specific applications for vertical markets may be addressed such as PMSE (Program Making and Special Events), medical, health, surgery, automotive, low-latency, drones, etc. applications. Furthermore, the apparatuses and methods described herein may also use radio communication technologies with a hierarchical application, such as by introducing a hierarchical prioritization of usage for different types of users (e.g., low/medium/high priority, etc.), based on a prioritized access to the spectrum e.g., with highest priority to tier-1 users, followed by tier-2, then tier-3, etc. users, etc. The apparatuses and methods described herein can also use radio communication technologies with different Single Carrier or OFDM flavors (CP-OFDM, SC-FDMA, SC-OFDM, filter bank-based multicarrier (FBMC), OFDMA, etc.) and e.g. 3GPP NR (New Radio), which can include allocating the OFDM carrier data bit vectors to the corresponding symbol resources.

For purposes of this disclosure, radio communication technologies may be classified as one of a Short Range radio communication technology or Cellular Wide Area radio communication technology. Short Range radio communication technologies may include Bluetooth, WLAN (e.g., according to any IEEE 802.11 standard), and other similar radio communication technologies. Cellular Wide Area radio communication technologies may include Global System for Mobile Communications (“GSM”), Code Division Multiple Access 2000 (“CDMA2000”), Universal Mobile Telecommunications System (“UMTS”), Long Term Evolution (“LTE”), General Packet Radio Service (“GPRS”), Evolution-Data Optimized (“EV-DO”), Enhanced Data Rates for GSM Evolution (“EDGE”), High Speed Packet Access (HSPA; including High Speed Downlink Packet Access (“HSDPA”), High Speed Uplink Packet Access (“HSUPA”), HSDPA Plus (“HSDPA+”), and HSUPA Plus (“HSUPA+”)), Worldwide Interoperability for Microwave Access (“WiMax”) (e.g., according to an IEEE 802.16 radio communication standard, e.g., WiMax fixed or WiMax mobile), etc., and other similar radio communication technologies. Cellular Wide Area radio communication technologies also include “small cells” of such technologies, such as microcells, femtocells, and picocells. Cellular Wide Area radio communication technologies may be generally referred to herein as “cellular” communication technologies.

Unless explicitly specified, the term “transmit” encompasses both direct (point-to-point) and indirect transmission (via one or more intermediary points). Similarly, the term “receive” encompasses both direct and indirect reception. Furthermore, the terms “transmit”, “receive”, “communicate”, and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception are handled by radio-layer components such as RF transceivers and antennas, and the logical transmission and reception over the software-level connection is performed by the processors or controllers. The term “communicate” encompasses one or both transmitting and receiving, i.e. unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations. The term “channel state information” is used herein to refer generally to the wireless channel for wireless transmission between one or more transmitting antennas and one or more receiving antennas and may take into account any factors that affect a wireless transmission such as, but not limited to, path loss, interference, and/or blockage.

An antenna port may be understood as a logical concept representing a specific channel or associated with a specific channel. An antenna port may be understood as a logical structure associated with a respective channel (e.g., a respective channel between a user equipment and a base station). Illustratively, symbols (e.g., OFDM symbols) transmitted over an antenna port (e.g., over a first channel) may be subject to different propagation conditions with respect to other symbols transmitted over another antenna port (e.g., over a second channel).

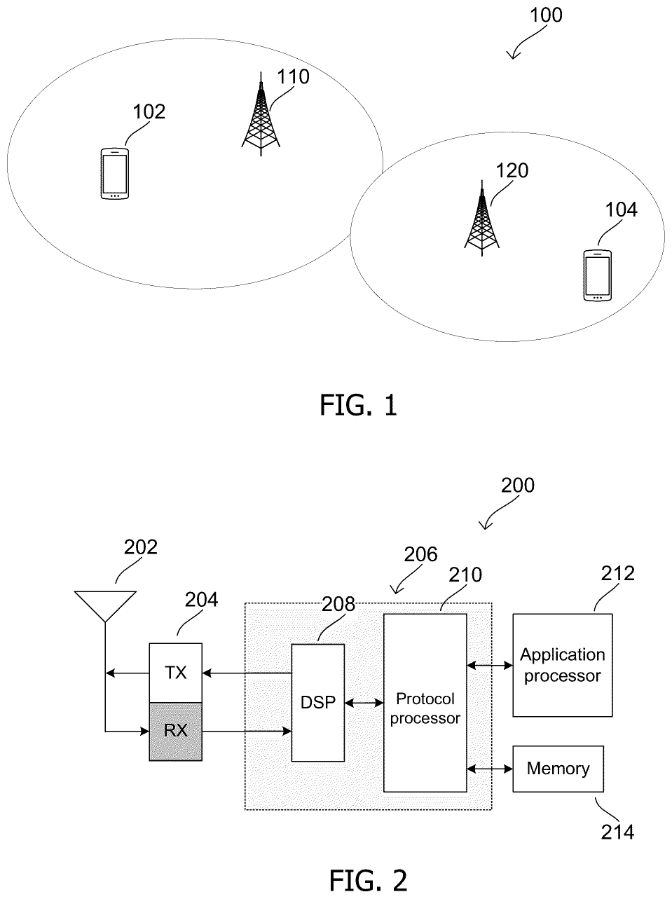

FIGS. 1 and 2 depict a general network and device architecture for wireless communications. In particular, FIG. 1 shows exemplary radio communication network 100 according to some aspects, which may include terminal devices 102 and 104 and network access nodes 110 and 120. Radio communication network 100 may communicate with terminal devices 102 and 104 via network access nodes 110 and 120 over a radio access network. Although certain examples described herein may refer to a particular radio access network context (e.g., LTE, UMTS, GSM, other 3rd Generation Partnership Project (3GPP) networks, WLAN/WiFi, Bluetooth, 5G NR, mmWave, etc.), these examples are demonstrative and may therefore be readily applied to any other type or configuration of radio access network. The number of network access nodes and terminal devices in radio communication network 100 is exemplary and is scalable to any amount.

In an exemplary cellular context, network access nodes 110 and 120 may be base stations (e.g., eNodeBs, NodeBs, Base Transceiver Stations (BTSs), gNodeBs, or any other type of base station), while terminal devices 102 and 104 may be cellular terminal devices (e.g., Mobile Stations (MSs), User Equipments (UEs), or any type of cellular terminal device). Network access nodes 110 and 120 may therefore interface (e.g., via backhaul interfaces) with a cellular core network such as an Evolved Packet Core (EPC, for LTE), Core Network (CN, for UMTS), or other cellular core networks, which may also be considered part of radio communication network 100. The cellular core network may interface with one or more external data networks. In an exemplary short-range context, network access node 110 and 120 may be access points (APs, e.g., WLAN or WiFi APs), while terminal device 102 and 104 may be short range terminal devices (e.g., stations (STAs)). Network access nodes 110 and 120 may interface (e.g., via an internal or external router) with one or more external data networks. Network access nodes 110 and 120 and terminal devices 102 and 104 may include one or multiple transmission/reception points (TRPs).

Network access nodes 110 and 120 (and, optionally, other network access nodes of radio communication network 100 not explicitly shown in FIG. 1) may accordingly provide a radio access network to terminal devices 102 and 104 (and, optionally, other terminal devices of radio communication network 100 not explicitly shown in FIG. 1). In an exemplary cellular context, the radio access network provided by network access nodes 110 and 120 may enable terminal devices 102 and 104 to wirelessly access the core network via radio communications. The core network may provide switching, routing, and transmission, for traffic data related to terminal devices 102 and 104, and may further provide access to various internal data networks (e.g., control nodes, routing nodes that transfer information between other terminal devices on radio communication network 100, etc.) and external data networks (e.g., data networks providing voice, text, multimedia (audio, video, image), and other Internet and application data). In an exemplary short-range context, the radio access network provided by network access nodes 110 and 120 may provide access to internal data networks (e.g., for transferring data between terminal devices connected to radio communication network 100) and external data networks (e.g., data networks providing voice, text, multimedia (audio, video, image), and other Internet and application data).

The radio access network and core network (if applicable, such as for a cellular context) of radio communication network 100 may be governed by communication protocols that can vary depending on the specifics of radio communication network 100. Such communication protocols may define the scheduling, formatting, and routing of both user and control data traffic through radio communication network 100, which includes the transmission and reception of such data through both the radio access and core network domains of radio communication network 100. Accordingly, terminal devices 102 and 104 and network access nodes 110 and 120 may follow the defined communication protocols to transmit and receive data over the radio access network domain of radio communication network 100, while the core network may follow the defined communication protocols to route data within and outside of the core network. Exemplary communication protocols include LTE, UMTS, GSM, WiMAX, Bluetooth, WiFi, mmWave, etc., any of which may be applicable to radio communication network 100.

FIG. 2 shows an exemplary internal configuration of a communication device according to various aspects provided in this disclosure. The communication device may include various aspects of network access nodes 110, 120 or various aspects of a terminal device 102 as well. The communication device 200 may include antenna system 202, radio frequency (RF) transceiver 204, baseband modem 206 (including digital signal processor 208 and protocol controller 210), application processor 212, and memory 214. Although not explicitly shown in FIG. 2, in some aspects communication device 200 may include one or more additional hardware and/or software components, such as processors/microprocessors, controllers/microcontrollers, other specialty or generic hardware/processors/circuits, peripheral device(s), memory, power supply, external device interface(s), subscriber identity module(s) (SIMs), user input/output devices (display(s), keypad(s), touchscreen(s), speaker(s), external button(s), camera(s), microphone(s), etc.), or other related components.

Communication device 200 may transmit and receive radio signals on one or more radio access networks. Baseband modem 206 may direct such communication functionality of communication device 200 according to the communication protocols associated with each radio access network, and may execute control over antenna system 202 and RF transceiver 204 to transmit and receive radio signals according to the formatting and scheduling parameters defined by each communication protocol. Although various practical designs may include separate communication components for each supported radio communication technology (e.g., a separate antenna, RF transceiver, digital signal processor, and controller), for purposes of conciseness the configuration of communication device 200 shown in FIG. 2 depicts only a single instance of such components.

Communication device 200 may transmit and receive wireless signals with antenna system 202. Antenna system 202 may be a single antenna or may include one or more antenna arrays that each include multiple antenna elements. For example, antenna system 202 may include an antenna array at the top of communication device 200 and a second antenna array at the bottom of communication device 200. In some aspects, antenna system 202 may additionally include analog antenna combination and/or beamforming circuitry. In the receive (RX) path, RF transceiver 204 may receive analog radio frequency signals from antenna system 202 and perform analog and digital RF front-end processing on the analog radio frequency signals to produce digital baseband samples (e.g., In-Phase/Quadrature (IQ) samples) to provide to baseband modem 206. RF transceiver 204 may include analog and digital reception components including amplifiers (e.g., Low Noise Amplifiers (LNAs)), filters, RF demodulators (e.g., RF IQ demodulators)), and analog-to-digital converters (ADCs), which RF transceiver 204 may utilize to convert the received radio frequency signals to digital baseband samples. In the transmit (TX) path, RF transceiver 204 may receive digital baseband samples from baseband modem 206 and perform analog and digital RF front-end processing on the digital baseband samples to produce analog radio frequency signals to provide to antenna system 202 for wireless transmission. RF transceiver 204 may thus include analog and digital transmission components including amplifiers (e.g., Power Amplifiers (PAs), filters, RF modulators (e.g., RF IQ modulators), and digital-to-analog converters (DACs), which RF transceiver 204 may utilize to mix the digital baseband samples received from baseband modem 206 and produce the analog radio frequency signals for wireless transmission by antenna system 202. In some aspects baseband modem 206 may control the radio transmission and reception of RF transceiver 204, including specifying the transmit and receive radio frequencies for operation of RF transceiver 204.

As shown in FIG. 2, baseband modem 206 may include digital signal processor 208, which may perform physical layer (PHY, Layer 1) transmission and reception processing to, in the transmit path, prepare outgoing transmit data provided by protocol controller 210 for transmission via RF transceiver 204, and, in the receive path, prepare incoming received data provided by RF transceiver 204 for processing by protocol controller 210. Digital signal processor 208 may be configured to perform one or more of error detection, forward error correction encoding/decoding, channel coding and interleaving, channel modulation/demodulation, physical channel mapping, radio measurement and search, frequency and time synchronization, antenna diversity processing, power control and weighting, rate matching/de-matching, retransmission processing, interference cancelation, and any other physical layer processing functions. Digital signal processor 208 may be structurally realized as hardware components (e.g., as one or more digitally-configured hardware circuits or FPGAs), software-defined components (e.g., one or more processors configured to execute program code defining arithmetic, control, and I/O instructions (e.g., software and/or firmware) stored in a non-transitory computer-readable storage medium), or as a combination of hardware and software components. In some aspects, digital signal processor 208 may include one or more processors configured to retrieve and execute program code that defines control and processing logic for physical layer processing operations. In some aspects, digital signal processor 208 may execute processing functions with software via the execution of executable instructions. In some aspects, digital signal processor 208 may include one or more dedicated hardware circuits (e.g., ASICs, FPGAs, and other hardware) that are digitally configured to specific execute processing functions, where the one or more processors of digital signal processor 208 may offload certain processing tasks to these dedicated hardware circuits, which are known as hardware accelerators. Exemplary hardware accelerators can include Fast Fourier Transform (FFT) circuits and encoder/decoder circuits. In some aspects, the processor and hardware accelerator components of digital signal processor 208 may be realized as a coupled integrated circuit.

Communication device 200 may be configured to operate according to one or more radio communication technologies. Digital signal processor 208 may be responsible for lower-layer processing functions (e.g., Layer 1/PHY) of the radio communication technologies, while protocol controller 210 may be responsible for upper-layer protocol stack functions (e.g., Data Link Layer/Layer 2 and/or Network Layer/Layer 3). Protocol controller 210 may thus be responsible for controlling the radio communication components of communication device 200 (antenna system 202, RF transceiver 204, and digital signal processor 208) in accordance with the communication protocols of each supported radio communication technology, and accordingly may represent the Access Stratum and Non-Access Stratum (NAS) (also encompassing Layer 2 and Layer 3) of each supported radio communication technology. Protocol controller 210 may be structurally embodied as a protocol processor configured to execute protocol stack software (retrieved from a controller memory) and subsequently control the radio communication components of communication device 200 to transmit and receive communication signals in accordance with the corresponding protocol stack control logic defined in the protocol software. Protocol controller 210 may include one or more processors configured to retrieve and execute program code that defines the upper-layer protocol stack logic for one or more radio communication technologies, which can include Data Link Layer/Layer 2 and Network Layer/Layer 3 functions. Protocol controller 210 may be configured to perform both user-plane and control-plane functions to facilitate the transfer of application layer data to and from radio communication device 200 according to the specific protocols of the supported radio communication technology. User-plane functions can include header compression and encapsulation, security, error checking and correction, channel multiplexing, scheduling and priority, while control-plane functions may include setup and maintenance of radio bearers. The program code retrieved and executed by protocol controller 210 may include executable instructions that define the logic of such functions.

Communication device 200 may also include application processor 212 and memory 214. Application processor 212 may be a CPU, and may be configured to handle the layers above the protocol stack, including the transport and application layers. Application processor 212 may be configured to execute various applications and/or programs of communication device 200 at an application layer of communication device 200, such as an operating system (OS), a user interface (UI) for supporting user interaction with communication device 200, and/or various user applications. The application processor may interface with baseband modem 206 and act as a source (in the transmit path) and a sink (in the receive path) for user data, such as voice data, audio/video/image data, messaging data, application data, basic Internet/web access data, etc. In the transmit path, protocol controller 210 may therefore receive and process outgoing data provided by application processor 212 according to the layer-specific functions of the protocol stack, and provide the resulting data to digital signal processor 208. Digital signal processor 208 may then perform physical layer processing on the received data to produce digital baseband samples, which digital signal processor may provide to RF transceiver 204. RF transceiver 204 may then process the digital baseband samples to convert the digital baseband samples to analog RF signals, which RF transceiver 204 may wirelessly transmit via antenna system 202. In the receive path, RF transceiver 204 may receive analog RF signals from antenna system 202 and process the analog RF signals to obtain digital baseband samples. RF transceiver 204 may provide the digital baseband samples to digital signal processor 208, which may perform physical layer processing on the digital baseband samples. Digital signal processor 208 may then provide the resulting data to protocol controller 210, which may process the resulting data according to the layer-specific functions of the protocol stack and provide the resulting incoming data to application processor 212. Application processor 212 may then handle the incoming data at the application layer, which can include execution of one or more application programs with the data and/or presentation of the data to a user via a user interface.

Memory 214 may embody a memory component of communication device 200, such as a hard drive or another such permanent memory device. Although not explicitly depicted in FIG. 2, the various other components of communication device 200 shown in FIG. 2 may additionally each include integrated permanent and non-permanent memory components, such as for storing software program code, buffering data, etc.

In accordance with some radio communication networks, terminal devices 102 and 104 may execute mobility procedures to connect to, disconnect from, and switch between available network access nodes of the radio access network of radio communication network 100. As each network access node of radio communication network 100 may have a specific coverage area, terminal devices 102 and 104 may be configured to select and re-select \ available network access nodes in order to maintain a strong radio access connection with the radio access network of radio communication network 100. For example, terminal device 102 may establish a radio access connection with network access node 110 while terminal device 104 may establish a radio access connection with network access node 112. In the event that the current radio access connection degrades, terminal devices 102 or 104 may seek a new radio access connection with another network access node of radio communication network 100; for example, terminal device 104 may move from the coverage area of network access node 112 into the coverage area of network access node 110. As a result, the radio access connection with network access node 112 may degrade, which terminal device 104 may detect via radio measurements such as signal strength or signal quality measurements of network access node 112. Depending on the mobility procedures defined in the appropriate network protocols for radio communication network 100, terminal device 104 may seek a new radio access connection (which may be, for example, triggered at terminal device 104 or by the radio access network), such as by performing radio measurements on neighboring network access nodes to determine whether any neighboring network access nodes can provide a suitable radio access connection. As terminal device 104 may have moved into the coverage area of network access node 110, terminal device 104 may identify network access node 110 (which may be selected by terminal device 104 or selected by the radio access network) and transfer to a new radio access connection with network access node 110. Such mobility procedures, including radio measurements, cell selection/reselection, and handover are established in the various network protocols and may be employed by terminal devices and the radio access network in order to maintain strong radio access connections between each terminal device and the radio access network across any number of different radio access network scenarios.

Many emerging communication technologies use beamforming techniques to improve communication performance. These beamforming techniques may operate by adjusting the phase of antennas in an array to produce radiation patterns of constructive and destructive interference. By shaping and steering these radiation patterns, radio communication devices can achieve high beamforming gains, which can in turn improve radio communication reliability and performance. This can be particularly beneficial in radio communication technologies that operate at high frequencies, such as millimeter wave (mmWave) technologies. Because these radio technologies may operate at carrier frequencies of 30 GHz and above, beamforming gains can be extremely helpful in compensating for the high pathloss often experienced at carrier frequencies in these ranges.

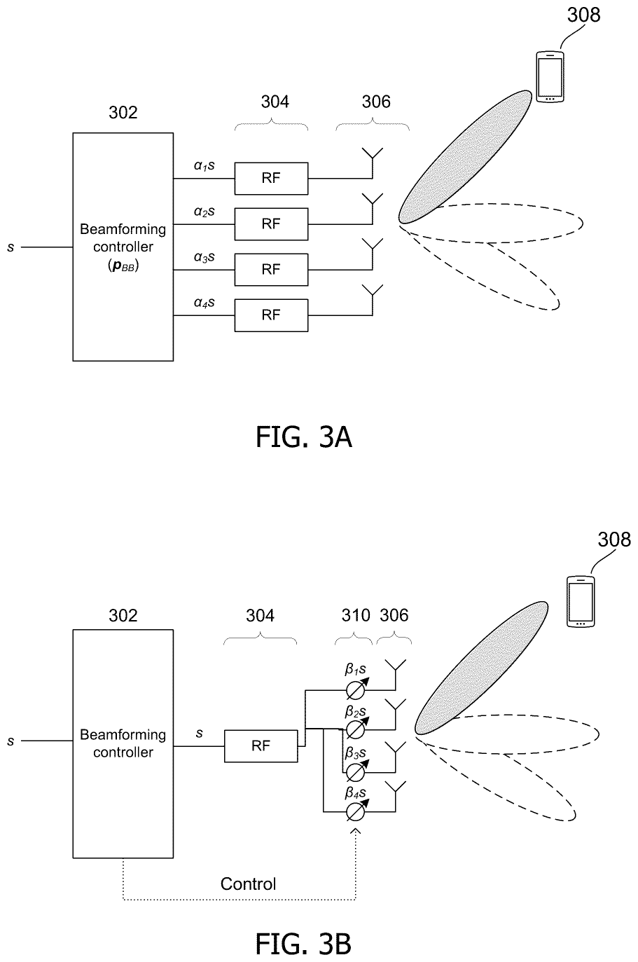

Beamforming systems may perform processing in one or both of the baseband and RF domains to shape antenna array beam patterns. FIGS. 3A and 3B show two simplified beamforming approach deployed for an exemplary four-element antenna array. Although the following description may focus on beamforming in the transmit direction, skilled persons can also apply analogous beamforming techniques to achieve beamforming gains in the receive direction.

FIG. 3A illustrates a simplified digital baseband beamforming architecture that digitally applies complex beamforming weights (composed of both a gain and phase factor) in the baseband domain. As shown in FIG. 3A, beamforming controller 302 may receive baseband symbol s and subsequently apply a complex weight vector p_{BB}=[α₁ α₂ α₃ α₄]^{T} to s to generate p_{BB}s, where each element αᵢ,i=1, 2, 3, 4 is a complex weight (comprising a gain factor and phase shift). Each resulting element [α₁ s α₂ s α₃ s α₄ s]^{T} of p_{BB}s may be baseband symbol s multiplied by some complex weight αᵢ. Beamforming controller 302 may then map each element of p_{BB}s to a respective RF chain of RF system 304, which may each perform digital to analog conversion (DAC), radio carrier modulation, and amplification on the received weighted symbols before providing the resulting RF symbols to a respective element of antenna array 306. Antenna array 306 may then wirelessly transmit each RF symbol. This exemplary model can also be extended to a multi-layer case where a baseband symbol vector s containing multiple baseband symbols s₁, s₂, etc., in which case baseband precoding vector p_{BB} may be expanded to a baseband precoding matrix pBB for application to baseband symbol vector s. In this case, αᵢ, i=1, 2, 3, 4 are row vectors, and p_{BB}s=[α₁ s α₂s α₃s α₄ s]^{T}. Thus, after multiplying p_{BB} and s, the overall dimension is the same as the overall dimension at the output of beamforming controller 302. The below descriptions thus refer to beamforming controller 302 as p_{BB} and transmit symbol/vector as s for this reason while this model can be extended to further dimensions as explained.

By manipulating the beamforming weights of p_{BB}, beamforming controller 302 may be able to utilize each of the four antenna elements of antenna array 306 to produce a steered beam (antenna beamforming pattern) that has greater beam gain than a single antenna element. The radio signals emitted by each element of antenna array 306 may combine to realize a combined waveform that exhibits a pattern of constructive and destructive interference that varies over distances and direction from antenna array 306. Depending on a number of factors (such as antenna array spacing and alignment, radiation patterns, carrier frequency, and the like), the various points of constructive and destructive interference of the combined waveform can create a focused beam lobe that can be “steered” in direction via adjustment of the phase and gain factors αᵢ of p_{BB}. FIG. 3A shows several exemplary steered beams generated by antenna array 306, which beamforming controller 302 may control by adjusting p_{BB}. Although only steerable main lobes are depicted in the simplified illustration of FIG. 3A, beamforming controller 302 may be able to comprehensively “form” the overall beam pattern including nulls and sidelobes through similar adjustment of p_{BB}.

Beamforming controller 302 may also perform adaptive beamforming, where beamforming controller 302 dynamically changes the beamforming weights in order to adjust the direction and strength of the main lobe in addition to nulls and sidelobes. With these adaptive approaches, beamforming controller 302 can steer the beam in different directions over time, which may be useful to track the location of a moving target point (e.g. a moving receiver or transmitter). In a radio communication context, beamforming controller 302 may identify the location of a target terminal device 308 (e.g. the direction or angle of terminal device 308 relative to antenna array 306) and subsequently adjust p_{BB} in order to generate a beam pattern with a main lobe pointing towards terminal device 308, thus improving the array gain at terminal device 308 and consequently improving the receiver performance. Through adaptive beamforming, beamforming controller 302 may be able to dynamically adjust or “steer” the beam pattern as terminal device 308 moves in order to continuously provide focused transmissions to terminal device 308 (or conversely focused reception).

In some aspects, beamforming controller 302 may be implemented as a microprocessor. Beamforming controller 302 therefore may be able to exercise a high degree of control over both gain and phase adjustments of p_{BB} with digital processing. However, as shown in FIG. 3A for RF system 304 and antenna array 306, digital beamforming configurations may use a dedicated RF chain for each element of antenna array 306 (where each RF chain performs radio processing on a separate weighted symbol αᵢs provided by beamforming controller 302); i.e. N_{RF}=N where N_{RF} is the number of RF chains and N is the number of antenna elements. Because there may be a complex assortment of circuitry in each RF chain (DAC, amplification, mixing, etc.), these digital beamforming approaches can be expensive and power-inefficient. These issues may be worsened as the involved number of antennas increases, which may be particularly problematic for the massive antenna arrays targeted for next-generation technologies that will include tens or even hundreds of antenna elements.

Contrasting with the beamforming controller architecture of FIG. 3A, FIG. 3B shows an RF beamforming approach. As shown in FIG. 3B, beamforming controller 302 may provide baseband symbol s to RF transceiver 304. RF transceiver 304 may perform RF transmit processing on baseband symbol s and provide the resulting symbol s to each of phase shifters 310. In the example shown in FIG. 3B, phase shifters 310 may include four phase shifters 310 that each apply a respective phase shift β₁ to β₄ to s. In some aspects, phase shifters 310 may be analog RF phase shifters that apply their respective phase shifts in the analog RF domain. Phase shifters 310 may provide the resulting phase-shifted symbols β₁ s to β₄s to antenna array 306. The respective antennas of antenna array 306 may wirelessly transmit the phase-shifted symbols. Similar to the operation of FIG. 3A s digital beamformer, FIG. 3B's RF beamformer may realize a specific antenna beamforming pattern by selecting the phase weights β₁ to Γ₄ (i.e. beamforming weights). Accordingly, beamforming controller 302 may be configured to select phase weights β₁ to β₄, such as based on the direction of terminal device 308, and provide the phase weights to β₁ to β₄ to phase shifters 310 (with the “Control” line shown in FIG. 3B). Beamforming controller 302 may therefore steer the main antenna beam towards terminal device 308 through proper selection of the phase weights β₁ to β₄. In some cases, the phase weights may be phase-only (e.g., only a phase shift with no amplitude change); in other aspects, the phase weights may have a phase and a gain component (e.g., a phase shift and an amplitude gain).

As introduced above, transmit and receive devices may use beamforming to increase transmission or reception sensitivity in certain directions. To do this, a device may select a set of beamforming weights and apply those beamforming weights to the elements of its antenna array. This may create a unique antenna beamforming pattern that transmits or receives signals with different sensitivity in different directions.

Wireless communication technologies like 5G NR and WiGig may use beamforming to increase link strength between terminal devices and network access nodes. Wireless devices may use this beamforming in both the transmit and receive directions. For example, a network access node may use receive beamforming by configuring its antenna array to receive with a specific antenna beamforming pattern that is steered toward a target terminal device. Similarly, in a transmit example, a network access node may configure its antenna array to transmit signals with a specific antenna beamforming pattern steered toward a target terminal device. Terminal devices may perform transmit and receive beamforming in the same manner.

Various radio communication technologies including the third generation wireless mobile telecommunication technology (3G), the fourth generation wireless mobile telecommunication technology (4G), and NR have included multiple-input multiple-output (MIMO) communication in various types such as Multi-User MIMO, Cooperative MIMO, and Massive MIMO with an intention to increase the spectral efficiency. In order to increase the throughput of the radio communication network and to support more users, there may be a tendency to increase the number of antennas used especially by network access nodes such as base stations (BS), for example, an evolved NodeB (eNB) or a next generation NodeB (gNB) or radio units (RUs).

With exposure to terabytes (TBs) of data from the multiple cells, different AI/ML based Radio Resource Management (RRM) algorithms are designed to learn from the user patterns, network data traffic patterns, and/or mobility patterns to optimize radio access network (RAN) operation. For example, RRM models associated with load balancing, CQI (Channel Quality Indicator) period optimization, connectivity optimization, optimization of RAN resources like MIMO usage, sub-band (frequency) usage, energy saving, etc. can be further optimized to support the workloads after learning past behaviors supported by the RAN.

There are certain key common and possibly central AI/ML models that can serve with different RRM algorithms, for example, load prediction, spectral efficiency prediction, traffic prediction, etc., which may help optimize RAN resources to meet workload requirements. Such an AI/ML model may have complexity at various levels, for example, deep Neural Networks (NNs), transformers. AI/ML models may require updates once deployed on the field, causing high latency in the inference and requiring high platform compute, memory, and storage capabilities for training as well as inference.

Furthermore, the employment of massive MIMO technology may be desirable to obtain high spectral efficiency in 5G, 6G, or any type of next mobile radio communication technology. Communication devices such as network access nodes and even terminal devices may include an antenna system including one or more antenna arrays that may include one or more subarrays to increase spatial diversity and data throughput. The increased number of antenna elements and also the increased number of antenna arrays/subarrays would result in further complexity in RF chains and RF management and also increased power consumption, in particular, due to components of respective RF chains. It may be desirable to adapt the power consumption and ecological footprints of deployments of radio communication devices including antenna systems with antenna arrays to the requirements of the workload in consideration of potential environmental considerations or regulations. It may be desirable, in particular, to maintain the performance of a radio communication device including an antenna system (e.g. a massive MIMO communication device) by the employment of a dynamic antenna configuration used to perform MIMO communication in consideration with power consumption based on overall cell environment and current/predicted workload.

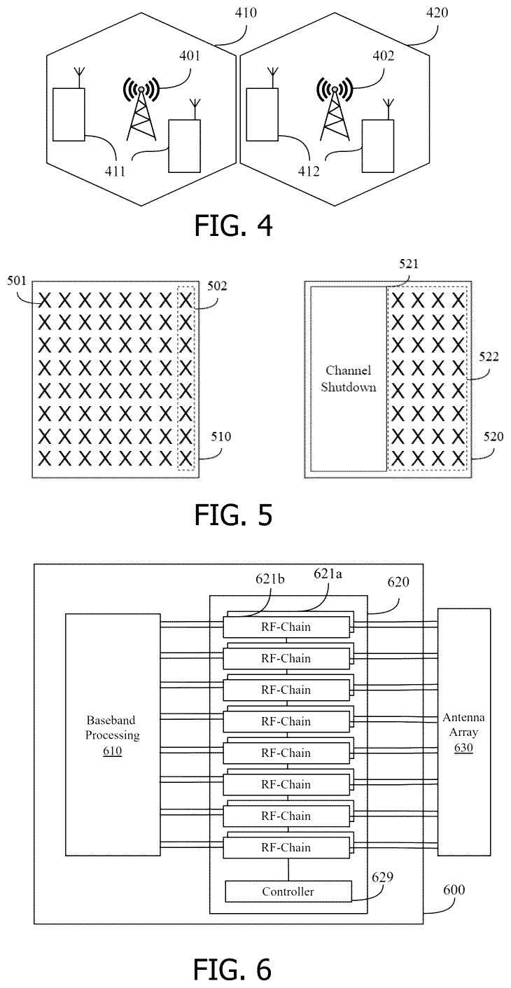

FIG. 4 shows an exemplary illustration of two cells of a mobile communication network. A cell may be a particular geographical region covered by one or more network access nodes providing radio access service. The size of a cell may depend on the mobile radio communication technology used by the network access node associated with the cell. For example, within the context of a wireless local area network (WLAN), a cell may have a radius of up to 100 meters, while within the context of cellular communication a cell may have a radius of up to 50 kilometers.

In this illustration, a first cell 410 is depicted as it includes a first network access node 401, such as a base station, and a second cell 420 is depicted as it includes a second network access node 402. The network access nodes 401, 402 may perform operations associated with the radio access network in order to provide radio coverage over the geographic areas that may be represented by the cells 410, 420 respectively. The first group of terminal devices 411 within the first cell 401 may access the mobile communication network over the first network access node 401, and the second group of terminal devices 412 within the second cell 402 may access the mobile communication network over the second network access node 402.

A network access node, such as a base station, may provide network access services to terminal devices within a cell. With the recent employment of distributed radio access networks, one or more remote radio units may be deployed for a cell to communicate with terminal devices within the cell using radio communication signals. Accordingly, in this illustration, the depicted network access nodes 401, 402 may include remote radio head units. Such remote radio units may be connected to further controller entities to communicate via wired (e.g. fronthaul) and/or wireless communications, and the controller entities (such as a controller unit, a central unit, a distributed unit) may manage radio resources associated with the one or more radio units within the cell.

Communication devices (e.g. network access nodes, user terminals) within the cell may include and may use antenna systems including antenna arrays to send or receive radio communication signals. An antenna array may include two or more antenna elements configured to operate as a single antenna to transmit and/or receive radio communication signals.

Conditions associated with mobile radio communication tend to change in time and space due to various reasons, such as weather conditions, the number of communication devices, radio signal interference, relative location of radio access nodes to terminal devices, terrain, etc. Furthermore, operator preferences may also affect such conditions, as, for example, communication conditions obtained based on an operator preference towards the power conservation may not be the same with communication conditions obtained based on another operator preference towards data throughput.

For example, in a RAN environment, conditions of each cell of the first cell 401 and second cell 402, such as cell traffic volume, cell Physical Resource Block (PRB) usage, number of users (i.e. terminal devices), performance indicators, etc., may be dynamic with respect to time and space. For example, in a particular cell, the PRB usage load may vary with time of the day and across multiple cells based on the geo-location. Moreover, the distribution of different cell conditions, for example, PRB usage, user density also may change with time. This degree of change of distribution varies from cell to cell as well as time, based on different characteristics of the cell, such as for example, cell topology, user density, average mobility, etc., which may indicate suitable massive MIMO configurations to maintain desired QoS. For example, a cell located near a highway may encounter more terminal devices during rush hours than any other times, considering that the highway is used more intensively by road users during the rush hours.

In accordance with various aspects provided herein, conditions of a cell (e.g. the first cell 410 or the second cell 420) may include an attribute associated with a state of the respective cell that is related to radio communication, such as, user density (i.e. density/number of terminal devices) within the cell, cell load of the cell (e.g. a ratio based on number of used PRBs and number of available PRBs, or number terminal devices that are connected to the network access node), location of the cell, the topology associated with the location of the cell (i.e. the topology of the geographical area covered in the cell), mobility of terminal devices within the cell that are served by the respective network access node (e.g. UEs in RRC_Connected mode), intra-cell cross-interference (i.e. cross-interference associated with radio communication between the group of terminal devices) within the cell and/or inter-cell cross-interference (i.e. cross interference associated with radio communication between cells (e.g. between the first cell 410 and the second cell 420)), power consumed by network access nodes providing radio access services to the cell (e.g. power consumption of RF circuits, power consumption of the antenna array, etc.), cell level QoS that may include data throughput within the cell (i.e. data rate between network access nodes and terminal devices within the cell) and/or spectral efficiency of the cell. In accordance with various aspects provided herein, a network access node (e.g. the first network access node 401 and/or the second network access node 402) or a further network entity connected to the network access node may obtain and/or determine various information that may represent the conditions of a respective cell. In various examples, the various information that may represent the conditions of a respective cell may be referred to as cell data.

In accordance with various aspects provided herein, cell data may represent the conditions of a cell. The cell data may include one data item associated with each of the above-mentioned condition attributes at a particular instance of time (e.g. the latest sample), or a plurality of data items for a plurality of time instances for each attribute, each of the plurality of data items is associated with the respective attribute for an instance of time of the plurality of time instances in order to represent the history associated with the respective attribute for a particular period of time represented by the plurality of time instances. For example, the cell data may include a time-series data associated with at least some of the attributes. The cell data may include any data that may represent or indicate the conditions of the cell that are associated with the radio communication and the above-mentioned examples should not be considered as limiting. In particular, the cell data may include a plurality of past data items for attributes, such as user density, cell load, mobility of terminal devices, data throughput, power consumption for transmitting and receiving radio communication signals by the network access node of the cell, etc.

FIG. 5 shows an example of different antenna configurations of a grid antenna array. A grid antenna array is depicted at a first configuration in 510. An antenna array may include a plurality of antenna elements 501. In this illustrative example, each antenna element 501 of the antenna array is configured to transmit and/or receive radio communication signals in two polarizations. As provided in this illustrative example, the grid antenna array may include a plurality of rows and a plurality of columns comprising the plurality of antenna elements 501. An antenna array may also include a plurality of subarrays 502. In this illustrative example, only one of the subarrays 502 is shown for brevity that is positioned vertically (i.e. the last column on the right hand side). An antenna array may also include horizontal subarrays. Theoretically, and also based on designated beamforming mechanism used with the antenna array, antenna elements of each subarray may be coupled to two RF-chains, each RF-chain including at least one mixer, a plurality of phase shifters for each of two polarizations. In the illustrated example, considering that the grid antenna array includes 8 subarrays (one subarray for every 8 elements positioned vertically as depicted in 502), and the grid antenna array is configured to transmit and/or receive radio communication signals in two polarizations, in a first configuration 510 in which all antenna elements/subarrays are used to transmit/receive radio communication signals, a power supply may provide electrical supply to 16 RF-chains.

In accordance with various aspects provided in this disclosure, various aspects may refer to antenna configurations. An antenna configuration of an antenna array may refer to a selection of antenna elements used to transmit and receive radio communication signals by the antenna array. In the above-mentioned first configuration 510 of the grid antenna array, a communication device including the grid antenna array may receive and/or transmit radio communication signals with all of the antenna elements of the grid antenna array in both polarizations. An antenna array may be associated with a plurality of antenna configurations. An antenna configuration may be based on a MIMO configuration or a beamforming configuration set by the respective communication device. In various aspects provided herein, an antenna configuration may include a configuration of the antenna array in which the communication device may receive and/or transmit radio communication signals only with a number of antenna elements wherein the number of antenna elements is smaller than the number of all antenna elements of the antenna array. An antenna configuration may include a configuration of the antenna array in which the communication device may receive and/or transmit radio communication signals via an antenna element only with a number of polarizations wherein the number of polarizations is smaller than the number of all polarizations supported by the respective antenna element.

In this illustrative example, the first configuration 510 of the grid antenna array may illustrate a configuration in which the communication device including the grid antenna array may receive and/or transmit radio communication signals at a capacity designated to a scenario that is fully operational, such as all RF-chains connected to the grid antenna array are operational to transmit and/or receive radio communication signals via all of the antenna elements 501. A further configuration of the antenna array may, in particular, include a configuration in which a selection of RF-chains of all RF-chains are operational, or in which only a selection of antenna elements 501 of all of the antenna elements are used to transmit and/or receive radio communication signals via the antenna array, or in which only a selection of polarizations of all polarizations are used to transmit and/or receive radio communication signals via one or more antenna elements of the antenna array.

A second configuration 520 of the grid antenna array is illustrated in 520. In this illustrative example, a subset of antenna elements of the antenna elements 501 of the grid antenna array is used to transmit and/or receive radio communication signals. In this illustrative example, transmitting and/or receiving radio communication signals via antenna elements corresponding to the first four vertical subarrays on the left-hand side of the grid antenna array are deactivated/disabled/shut down which may be referred to as channel shutdown 521. The communication device including the grid antenna array according may only transmit and/or receive radio communication signals via the subset of antenna elements depicted as 522 according to the second configuration 520.

FIG. 6 shows an exemplary illustration of various communication elements of a communication device. The communication device 600 may include a baseband processing circuitry 610 (e.g. the baseband modem 206) that may direct communication functionality of communication device 600 according to communication protocols associated with the radio access network, and may execute control over an antenna array 630 (e.g. the grid antenna array in FIG. 5). The communication device 600 may include the antenna array 630, or may include an antenna interface couplable to the antenna array 630. The communication device 600 may transmit and receive radio communication signals with the antenna array 630.

As mentioned in FIG. 5, the antenna array 630 may include subarrays (e.g. 8 subarrays), but in various examples, the block depicted as the antenna array 630 may include a plurality of antenna arrays (e.g. 8 antenna arrays). In some aspects, the antenna array 630 may be an antenna module or antenna unit that may include analog antenna combination and/or beamforming circuitry.

In a receive (RX) path, RF chains of an RF circuitry 620 may receive analog radio frequency signals from the respective subarrays of the antenna array 630 and perform analog and digital RF front-end processing on the analog radio frequency signals to produce digital baseband samples (e.g., In-Phase/Quadrature (IQ) samples) to provide to the baseband processing circuitry 610. RF circuitry 620 may include two RF-chains 621a, 621b per subarray of the antenna array 630, each RF-chain may be designated for a polarization for this illustrative example in which each antenna element of the antenna array is configured to two orthogonal polarizations. Each RF-chain of the RF circuitry 620 may include analog and digital reception components including amplifiers (e.g., Low Noise Amplifiers (LNAs)), filters, RF demodulators (e.g., RF IQ demodulators)), and analog-to-digital converters (ADCs), which each RF chain may utilize to convert the received radio frequency signals to digital baseband samples.

In a transmit (TX) path, each RF chain of the RF circuitry 620 may receive digital baseband samples from baseband processing circuitry 610 and perform analog and digital RF front-end processing on the digital baseband samples to produce analog radio frequency signals to provide to respective subarrays of the antenna array 630 for radio transmission. Each RF chain of the RF circuitry 620 may thus include analog and digital transmission components including amplifiers (e.g., Power Amplifiers (PAs), filters, RF modulators (e.g., RF IQ modulators), and digital-to-analog converters (DACs), which each RF chain may utilize to mix the digital baseband samples received from baseband processing circuitry 610 and produce respective analog radio frequency signals for radio transmission by the respective subarray of the antenna array 630. In some aspects, the baseband processing circuitry 610 may control the radio transmission and reception of each RF chain of the RF circuitry 620, including specifying the transmit and receive radio frequencies for the operation of the RF circuitry 620.

The baseband processing circuitry may include a digital signal processor (e.g. the digital signal processor 208). The digital signal processor 208 may be configured to perform one or more of error detection, forward error correction encoding/decoding, channel coding, and interleaving, channel modulation/demodulation, physical channel mapping, radio measurement and search, frequency and time synchronization, antenna diversity processing, power control, and weighting, rate matching/de-matching, retransmission processing, interference cancelation, and any other physical layer processing functions.

In accordance with various aspects provided herein, the RF circuitry 620 may further include a controller 629 to supply power (e.g. electrical supply, voltage) to various components of each RF-chain based on the designated antenna configuration. For an antenna configuration in which a subset of antenna elements are to be used to transmit and/or receive radio communication signals, the controller 629 may supply components of the respective RF chains that are coupled to the subset of antenna elements.

Exemplarily, for the illustrated second configuration 520, the controller 629 may supply power to respective RF chains of the respective subarrays according to the selected subset of antenna elements 522 according to the second configuration. The controller 629 may further cause other RF chains of subarrays of the antenna array 630 corresponding to the channel shutdown region 521 of the grid antenna array to operate in a low power mode, or in a deactivated/disabled mode, reducing power consumption of the respective other RF chains.

In certain configurations and under certain conditions, RF equipments of a network access node such as a BS (e.g. a gNB) may consume/expected to consume up to 70-80% of energy in 5G radio communications/emerging mobile radio communications. For Massive MIMO adoption, a cell of a mobile communication network may be associated with antenna grids in an order of hundreds or thousands of antenna elements to provide seamless quality of services (QoS) to terminal devices that may result in consumption of considerable amount of power. It may be desirable to reduce power consumption by shutting down/disabling/deactivating some RF chains/antenna elements of an antenna grid, that is referred to a configuration with a channel shutdown, to save power. Different combinations of active RF chains/antenna elements used to transmit and/or receive radio communication signals may define multiple massive MIMO configurations.

As the conditions associated with mobile radio communication tend to change in time and space, it may be desirable to operate antenna arrays within a cell based on the conditions of the respective cell. For example, the conditions of the cell may indicate that an antenna array of a network access node may operate with a different configuration that may reduce the power consumption of the respective network access node. Exemplarily, a network access node may be configured to transmit and/or receive radio communication signals with an antenna array in the first configuration 510 based on conditions of the cell at a first instance of time, which the conditions may indicate a cell load above a first predefined cell load, and the network access node may be configured to transmit and/or receive radio communication signals with the antenna array in the second configuration 520 based on conditions of the cell at a second instance of time, which the conditions may indicate a cell load below a second predefined cell load.

For example, in some cases when the number of terminal devices with the cell is low, a fraction (e.g. a half, a quarter, ¾, ⅞, 63/64) of the antenna array may be sufficient to maintain QoS requirements for terminal devices in the cell while conserving power, and at some conditions, the antenna array may be fully operational. The skilled person would recognize that there may be an innate tradeoff between QoS for radio communication within the cell and power consumed by one or more network access nodes serving the cell via the respective configurable antenna array based on RF-chains and antenna elements that are in use/not in use.

It may further be desirable to manage antenna configurations to be used by one or more network access nodes within the cell based on preferences of a mobile network operator (MNO) that may represent a preference toward data throughput (QoS) or a preference toward power conservation. For example, an operator may prefer to prioritize power saving in a cell near a stadium when there are no games scheduled at the stadium, and the operator may prioritize QoS when there is a game scheduled at the stadium for a certain period of time.

Accordingly, it may be desirable to determine an antenna configuration for an antenna array of a cell of a mobile communication network based on conditions of the respective cell, and optionally based on preferences of an operator that may bias the determination of an antenna configuration towards a power conservation or towards a QoS. The determined antenna configuration may cause using only a subset of antenna elements of an antenna array to transmit and/or receive radio communication signals, thereby various components of the antenna array and respective RF-chains not corresponding the subset of antenna elements may operate in a low power mode or may be deactivated. In various examples, it may be desirable to maximize an objective that is configured to balance power saving and cell spectral efficiency and/or cell throughput based on preferences of the MNO.

In accordance with various aspects provided herein, a device may use a trained artificial intelligence/machine learning model (AI/ML) to determine the respective antenna configuration based on cell data that is representative of conditions of the cell at a particular instance of time, that may be based on a particular period of time. It may be desirable to minimize data and processor overhead required to train or optimize the AWL/trained AWL. In various aspects, a RAN intelligent controller (RIC) may implement the trained AWL that could be onboard the RAN or that may be reachable over mobile communication network to maintain a bounded latency for radio communication.

In accordance with various aspects provided herein, a network access node of a cell may implement the trained AI/ML model(s) as provided in this disclosure. In accordance with various aspects provided herein, a further entity other than the network access node within the mobile communication network may implement the respective trained AI/ML model. For example, in a distributed RAN architecture (e.g. Open RAN), a central unit (O-CU (e.g. O-CU-Control Plane (CP))) may implement the trained AI/ML model. In various examples, a near real-time RAN intelligent controller (a near RT RIC) may implement the trained AI/ML model. In such a case, an xApp may include the trained AI/ML model. In a scenario, in which the further entity implements the trained AI/ML model, the respective further entity may communicate with the network access node or other further entities within the mobile communication network in order to receive data, based on which the respective further entity may obtain input data of the trained AI/ML model that provides the output based on the input data.

In accordance with various aspects provided herein, a determination of an antenna configuration may include stages. For an antenna array having a number of antenna elements, it may be challenging, tedious, and computationally ineffective to check each possible combination of antenna elements of the antenna array based on the conditions of the cell to select a particular antenna configuration among them. Accordingly, it may be desirable to employ an approach having multiple stages to determine an antenna configuration. For example, a processor may determine, at a first stage and based on conditions of the cell at a first instance of time (e.g. the cell conditions at the first stage), a set of configurations of the antenna array, in which each configuration of the set of configurations may include a subset of antenna elements of the antenna array that may be used to transmit and/or receive radio communication signals. In other words, each configuration of the set of configurations may include a first set of antenna elements that are to be used to transmit and/or receive radio communication signals with the antenna array and a second set of antenna elements that are not to be used to transmit and/or receive radio communication signals with the antenna array for a predetermined period of time.

Then, at each further stage, the processor may select one of the antenna configurations from the determined set of configurations based on conditions of the cell at a further instance of time that is after the first instance of time (e.g. cell conditions at a stage after the first stage). In various examples, the processor may perform the first stage determination, and then perform multiple further stage selections at each predetermined time interval for multiple time intervals. For example, the processor may perform, for each performed first stage determination, N number of further stage selections (N being an integer with a minimum N being 1), each further stage selection is based on conditions of the cell at a respective instance of time (e.g. conditions of the cell based on latest cell data, conditions of the cell based on cell data at the instance of time of the respective further stage selection, etc.). For example, the processor may perform the first stage determination with a first periodicity, and the processor may perform multiple further stage selections with a second periodicity within one period defined by the first periodicity. For example, the processor may perform the first stage determination with a period of T, and the processor may perform each further stage selection with a period of T/N, where N is an integer having a minimum value of 2. For example, the processor may perform the first stage determination every day, while the processor may perform each further stage selection with a period of 15 minutes (i.e. N=96).

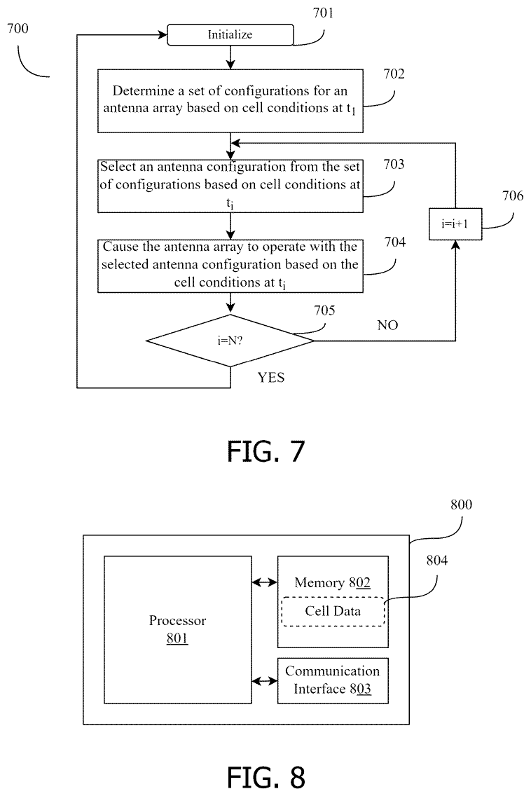

FIG. 7 shows an example of a procedure to select an antenna configuration in accordance with various aspects provided herein. A processor (e.g. the processor 800) may perform the procedure 700. The procedure 700 may start with an initialization 701 that may include obtaining cell data representative of cell conditions for t₁, setting i=1, determining instances of time associated with t₁ as exemplarily illustrated for the procedure, obtaining operator information, etc. The processor may determine 702 a set of configurations for an antenna array based on cell conditions at t₁. Each antenna configuration of the set of configurations may include an antenna configuration in which a subset of antenna elements are to be used to transmit and/or receive radio communication signals. Each antenna configuration may include a first set of antenna elements that are to be used to transmit and/or receive radio communication signals, and a second set of antenna elements that are not to be used to transmit and/or receive radio communication signals. The determination 702 may be the first stage determination.

Furthermore, the processor may select 703, for each further stage, an antenna configuration from the determined set of configurations based on cell conditions at In this illustrative example, each further stage is indicated by the index i. The processor 703 may be configured to select a new antenna configuration based on new cell conditions N times, which may be predetermined, and accordingly, the index i that was initialized with 1 is increased by 1. Accordingly, the processor may cause 704, for each further stage, the antenna array to operate with the antenna configuration that is selected based on the cell conditions at In other words, each further stage may be a stage to select an antenna configuration for a particular time interval after the determination 702, that may begin, end, or include tᵢ.

Causing the antenna array to operate with the selected antenna configuration may include configuring an antenna system including the antenna array to transmit and/or receive radio communication signals only with the subset of antenna elements that are to be used according to the selected antenna configuration, configuring other antenna elements of the antenna array to be deactivated/disabled, configuring RF-chains coupled to the other antenna elements of the antenna array to operate in a low power mode or in a deactivated/disabled mode, providing information to a respective processor coupled to the antenna array so that the respective processor may be configured accordingly. Accordingly, the above-mentioned second set of antenna elements that are not to be used to transmit and/or receive radio communication signals, and respective RF-chains coupled to the second set of antenna elements may operate in a low power mode or in a deactivated/disabled mode.

In accordance with various aspects provided herein, a communication device may include the antenna array, and a further entity (e.g. a further device, a network function, etc.) including the processor may implement the procedure 700. Accordingly, the further entity may also encode information representative of the selected antenna configuration to send the encoded information to the communication device to cause the antenna array to operate with the selected antenna configuration.

In this illustrative example, a simple counter is used to indicate further stages. Accordingly, the processor may check 705 if the number of further stages (i) has reached N. If i is not equal to N, the processor may increase 706 i with 1 and select another antenna configuration from the determined set of configurations based on cell conditions at tᵢ₊₁ and cause the antenna array to operate with the selected another antenna configuration. If i is equal to N, the processor may stop the procedure 700, or repeat the procedure 700 by determining a new set of configurations based on cell conditions at a new t₁.

FIG. 8 shows an example of a device 800 according to various examples in this disclosure. The device 800 is depicted as a communication device (e.g. the communication device 200) in this illustrative example, including a processor 801, a memory 802, and a communication interface 803 configured to receive and transmit communication signals in order to communicate with further entities within the mobile communication network. The communication interface 803 may include a transceiver. The processor 801 may include one or more processors which may include a baseband processor and an application processor. In various examples, the processor 801 may include a central processing unit, a graphics processing unit, a hardware acceleration unit, a neuromorphic chip, and/or a controller. The processor 801 may be implemented in one processing unit, e.g. a system on chip (SOC), or a processor. In accordance with various examples, the processor 801 may further provide further functions to process received communication signals. The memory 802 may store various types of information required for the processor 801, or the communication interface 803 to operate in accordance with various aspects of this disclosure.

The memory 802 may be configured to store cell data 804 representative of the one or more attributes associated with at least one state of the cell, such as conditions of the cell as exemplarily defined in accordance with FIG. 4. The processor 801 may have obtained the cell data 804 based on its operations, exemplarily as operations of a network access node serving terminal devices within the cell, by communicating with the terminal devices, or based on previous radio resource management operations for the cell. For example, the processor 801 may decode various messages received from terminal devices (e.g. UE reports, radio communication channel indicators and measurements associated with radio communication channels, UEInformationResponse) via the communication interface 803, by which the processor 801 may obtain through collection of data, or via estimations, attributes associated with one or more states associated with conditions of the cell.

Furthermore, the processor 801 may obtain, through execution of radio resource management operations (by the device 800 itself, or by another entity which the device 800 may communicate via the communication interface 803), information with respect to user density, mobility of terminal devices, interference information, cell load of the cell, location of the cell, the topology associated with the location of the cell, mobility of terminal devices within the cell that are served by the respective network access node, computing resources used by the respective network access node, and/or used by a radio resource managing entity associated with the network access node, in order to manage radio resources of the cell, cross-interference, power consumed by network access nodes providing radio access services to the cell (e.g. power consumption of RF circuits, power consumption of the antenna array, etc.), cell level QoS that may include data throughput (i.e. data rate between network access nodes and terminal devices within the cell). The processor 801 may also obtain the location information associated with the cell by the location of the device 800 (e.g. stored in the memory 802, or via a positioning (e.g. GPS) system) and respective topology associated with the location of the device 800.

In various examples, the processor 801 may obtain the cell data 804 via the communication interface 803 by communicating with one or more other entities within the mobile communication network, and the one or more other entities may have obtained the respective information associated with the conditions of the cell similarly, as defined herein. In particular, the processor 801 may decode cell state information received from a further communication device that may manage radio resources of the cell of the mobile communication network and store the decoded cell state information in the memory 802 as the cell data 804.

The processor 801 may control the exchange of information with further entities of the mobile communication network via the communication interface 803. In particular, in case the processor 801 obtains the cell data 804 by receiving information (e.g. cell state information) associated with the conditions of the cell, the processor 801 may encode requests for further entities that provide the information associated with the conditions of the cell, to receive and update the cell data 804 stored in the memory 802 from time to time (e.g. periodically, in response to a received request for selection/determination of an antenna configuration, etc.).

Furthermore, some aspects provided herein may include determinations based on operator information representative of preferences of a mobile network operator (MNO) associated with the mobile network service provided by the cell. The MNO may prefer an operation prioritizing power conservation over data throughput, or prioritizing data throughput over power conservation. Moreover, as the mobile communication network may include many cells and/or many access network nodes comprising antenna arrays configurable as provided herein, the MNO may prioritize or limit the determination/selection of an antenna configuration for particular cells or for particular network access nodes. Additionally, the MNO may also provide various limitations associated with an antenna array for which an antenna configuration is to be selected.

In accordance with various aspects provided herein, the device 800 may communicate via the communication interface 803 with an entity of the mobile communication network, which the entity may provide the operator information including information representative of above-mentioned preferences of the MNO. For example, the operator information may include information representing priority cells for which an antenna configuration is to be selected, priority network access nodes for which an antenna configuration is to be selected, a performance threshold, a weight parameter associated with the data throughput or power conservation preferred by the MNO, etc. The entity that provides the operator information may be an orchestrator entity of the mobile communication network (e.g. a service management and orchestration (SMO) entity in O-RAN).

In accordance with various aspects provided herein, the device 800 may perform various operations for at least one antenna array deployed in a cell. In various examples, the device 800 may include the at least one antenna array. In such an example, the device 800 may include a communication device (e.g. the communication device 600) that may include an RF circuitry (e.g. the RF circuitry 620) and an antenna array (e.g. the antenna array 630) including a plurality of antenna elements. In such an example, the device 800 may be a network access node of the cell. Hence, the device 800 may select an antenna configuration for the antenna array of the device 800 based on the conditions of the cell that the device 800 operates within. The device 800 may store antenna array information in the memory 802 that is associated with the antenna array, such as at least one of a number of antenna elements, a number of subarrays, a number of antenna arrays of the device 800, antenna performance metrics, and/or antenna requirements.

In various examples, the device 800 may communicate with a further entity including an antenna array including a plurality of antenna elements within a cell of the mobile communication network. The further entity may include the communication device as exemplarily provided in FIG. 6. In such an example, the further entity may include a baseband processing circuitry (e.g. the baseband processing circuitry 610), an RF circuitry (e.g. the RF circuitry 620), and an antenna array (e.g. the antenna array 630) configured to operate in a cell of the mobile communication network, and the processor 801 may determine/select an antenna configuration for the antenna array of the further entity based on conditions of cell that the further entity operates within. In such an example, the device 800 may also receive antenna array information associated with the antenna array, such as a number of antenna elements, a number of subarrays, a number of antenna arrays of the further entity, antenna performance or antenna requirements.

The processor 801 may be configured to select an antenna configuration for an antenna array deployed in a cell based on the cell data 804 representing conditions of the cell. In accordance with various aspects provided herein, the processor 801 may select the antenna configuration, exemplarily as provided with respect to FIG. 7.

Accordingly, the processor 801 may determine a set of configurations for the antenna array based on the cell data 804 representing conditions of the cell in which the antenna array is deployed at a first stage at an instance of time. Each configuration of the set of configurations may include an antenna configuration that is representing a subset of antenna elements of the antenna array that is going to be used to transmit and/or receive communication signals (perform communications) within the cell. The determined set of configurations may provide computational comfort to the processor 801 for further stages to select an antenna configuration for the antenna array, as checking each possible antenna configuration for an antenna array for each iteration or for every new instance of time may cause a computation overhead that may not be desirable. The processor 801 may determine a predefined number of antenna configurations as the set of configurations (e.g. 10 antenna configurations) with an intention to coarsely determine possible configurations that can be used for a period of time that is longer than a period of time that a particular antenna configuration is to be selected for the antenna array.

In various examples, the antenna array may include a plurality of rows and a plurality of columns. The determined set of configurations may include antenna configurations in which a subset of the plurality of rows and/or a subset of the plurality of columns are to be used to perform communications within the cell. In various examples, aspects associated with antenna arrays may include operations based on subarrays of the antenna array. Accordingly, a determined set of configurations may include antenna configurations in which a subset of antenna arrays are to be used to perform communications. Furthermore, selecting an antenna configuration may result in selecting antenna elements, based on the determined set of configurations, to be used to perform communications. In various examples, a selected antenna configuration includes a subset of subarrays of the respective antenna array.

Furthermore, the processor 801 may select one or more antenna configurations for the antenna array from the determined set of configurations at further instances of time as further stages of the antenna selection procedure. For each further stage, the processor 801 may select an antenna configuration from the determined set of configurations based on the cell data 804 representing conditions of the cell at a further instance of time. The processor 801 may cause the antenna array to be configured with the selected antenna configuration for a period of time.

As disclosed herein, in an example in which the device 800 includes the antenna array, the processor 801 may configure the baseband processing operations, the RF circuitry, and the antenna array to transmit and/or receive radio communication signals with the subset of the plurality of antenna elements of the antenna array according to the selected antenna configuration, and the processor 801 may deactivate/disable and/or operate in a lower power mode, the respective components corresponding other plurality of antenna elements of the antenna array that are not in the subset. In an example, that another entity includes the antenna array, the processor 801 may encode information representing the selected antenna configuration and the device 800 may send the encoded information via the communication interface 803 to the another entity which then may perform operations as disclosed herein to deactivate/disable and/or operate in a lower power mode.

In accordance with various aspects provided herein, the processor 801 may determine the set of configurations based on the cell data 804 that is representative of conditions of a cell at the first stage for a greater period of time than the period of time which the cell data 804 is representative of conditions of the cell at further stages. Accordingly, the determination of the set of configurations may be based on conditions of the cell for a longer term than the term used to represent conditions of the cell for the selection of the antenna configuration from the determined set of configurations. The processor 801 may determine the set of configurations for a predetermined period of time (e.g. three days, one week, one month, etc.) that is greater than a period of time (e.g. N times, as disclosed with respect to FIG. 7) for which the processor 801 may select an antenna configuration from the determined set of configurations (e.g. 15 minutes, 30 minutes, one hour, etc.).

The processor 801 may determine the set of configurations based on the conditions of the cell at the first stage, by predicting a performance metric for the communication operations within the cell based on the cell data 804. The processor 801 may select the set of configurations based on the conditions of the cell at further stages, by predicting a performance metric for the communication operations within the cell based on the cell data 804. In accordance with various aspects provided herein, a performance metric may include data throughput and/or spectral efficiency (i.e. data throughput per a given spectrum resource) associated with the respective antenna array within the cell. The data throughput may include a rate (an amount per period of time) of data sent to terminal devices within the cell by the network access node with the antenna array, and/or a rate of the data received from terminal devices within the cell by the network access node with the antenna array, in which the sum of both rates may result in a system throughput or aggregate throughput that may also be referred to as the data throughput of the cell. For example, the cell data may include information representative of the data throughput within the cell for a plurality of time instances, and as an exemplary prediction method, the processor 801 may predict the data throughput at a future instance of time based on the past data throughput within the cell for a plurality of past time instances using a regression model.

In accordance with various aspects provided herein, a performance metric may include power consumption associated with the cell. The power consumption may include a rate of power consumption by the further entity that includes the antenna array (i.e. network access node) and/or particular power consumption of the antenna array and/or the respective RF circuitry of the further entity. For example, the cell data may include information representative of the power consumption associated with the further entity for a plurality of time instances, and as an exemplary prediction method, the processor 801 may predict a power consumption rate at a future instance of time based on the past power consumption associated with the cell for a plurality of past time instances using a regression model.

In accordance with various aspects provided herein, a performance metric may include cell load of the cell. The cell load may include a rate of used PRBs and/or available PRBs, or a rate of terminal devices that are connected to the network access node. For example, the cell data 804 may include information representative of the cell load of the cell for a plurality of time instances, and as an exemplary prediction method, the processor 801 may predict a cell load at a future instance of time based on the past cell load of the cell for a plurality of past time instances using a regression model.

In accordance with various aspects provided herein, a performance metric may include cell load of the cell. The cell load may include a rate of used PRBs and/or available PRBs, or a rate of terminal devices that are connected to the network access node. For example, the cell data 804 may include information representative of the cell load of the cell for a plurality of time instances, and as an exemplary prediction method, the processor 801 may predict a cell load at a future instance of time based on the past cell load of the cell for a plurality of past time instances using a regression model.

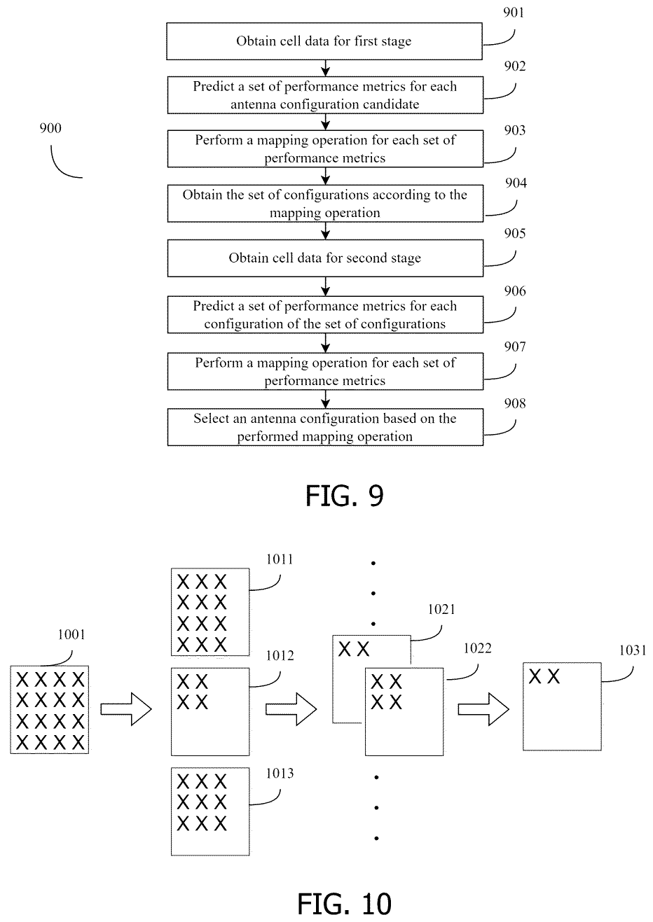

FIG. 9 shows an exemplary procedure to select an antenna configuration. A processor (e.g. the processor 801) may implement the procedure 900. The processor may obtain 901 cell data representing conditions of a cell for a first period of time. For example, the cell data may include information representing data throughput obtained by performing communications with the antenna array and power consumption associated with communicating using the antenna array (i.e. total power consumption of the network access node) for the period of time with a plurality of data items, each data item may represent a value associated with the respective performance metric for a particular time instance within the first period of time. The cell data may further include information representative of antenna configuration that was used with respect to these performance metrics.

The processor may predict 902 a set of performance metrics for each antenna configuration candidate of multiple antenna configurations of the antenna array. The multiple antenna configurations may include predefined antenna configurations of the antenna array stored in a memory (e.g. the memory 802). The predefined antenna configurations may be obtained via the antenna array information or the operator information that may represent preferred antenna configurations; or may be provided by a user of the device according to expected outcomes or limitations. For example, each antenna configuration candidate may include an antenna configuration in which only a subset of rows of the antenna array and/or only a subset of columns of the antenna array is to be used to perform communications.

The processor may predict 902 the set of predetermined performance metrics for each antenna configuration candidate. For example, the MNO may further indicate preference for performance metrics to be used by the processor via the operator information sent by the orchestrator entity. For this particular example, the operator information may indicate that the performance metrics to be used to determine the set of configurations for the antenna array are data throughput and power consumption. Accordingly, for each antenna configuration candidate, the processor may predict data throughput to be obtained by performing communications with the antenna array and the power consumption associated with performing communications using the antenna array based on the obtained cell data for the first stage using a prediction model (e.g. a regression model).

The processor may perform 903 a mapping operation based on each set of performance metrics predicted for one of the antenna configuration candidates to perform calculations. For example, the MNO may indicate preference of an objective for the calculations via the operator information. The objective may indicate how the performance metrics are related to the determination procedure 900. In other words, the indicated objective may indicate a criterion (or criteria) to determine the set of configurations. The MNO may indicate the objective by sending operator information representing a mathematical formula that is used to obtain a performance value based on parameters of the mathematical formula that are the predicted set of performance metrics. Alternatively, or additionally, the MNO may send a mapping table that matches a plurality of predefined performance metrics of the set of performance metrics.

For this illustrative example, the operator information includes information representing a mathematical formula based on a first parameter associated with a predicted data throughput and a second parameter associated with a predicted power consumption. The processor may calculate a value using the mathematical formula for each set of predicted data throughput and predicted power consumption for each antenna configuration candidate using the mathematical formula. The operator information may also include information representing the criterion as the maximum calculated value is to be selected, and the operator information may further include a number of antenna configurations to be selected as the determined set of configurations.

The processor may accordingly obtain 904 the set of configurations according to the above-mentioned mapping operation. In this illustrative example, the processor may obtain multiple values for the multiple antenna configuration candidates, each value for each antenna configuration candidate is obtained by performing a mapping operation according to the mathematical formula, that maps the respective predicted data throughput and the respective predicted power consumption for the respective antenna configuration candidate to the respective value. The processor may then select 904 a number of antenna configuration candidates, which have the highest obtained value, as indicated by the criterion, in order to obtain the determined set of configurations.

The processor may obtain 905 cell data representing conditions of the cell for a second period of time for a second stage. The second period of time may include a period of time that is after than the first period of time. In various examples, the time period that is defined with the second period of time is shorter than the time period that is defined with the first period of time, but it may also be longer. The processor may repeat steps 905-908 of the procedure for further stages.

The processor may predict 906 a set of performance metrics for each antenna configuration of the determined set of configurations of the antenna array. The determined set of configurations of the antenna array may have been stored in a memory (e.g. the memory 802). The processor may predict 906 the set of predetermined performance metrics for each antenna configuration of the determined set of configurations of the antenna array. For example, the MNO may further indicate preference of performance metrics to be used by the processor via the operator information sent by the orchestrator entity. For this particular example, the operator information may indicate that the performance metrics to be used to select an antenna configuration based on the determined set of configurations for the antenna array are also data throughput and power consumption, but it may have been other performance metrics as well, which the processor may perform the selection similarly based on other performance metrics indicated in the operator information. Accordingly, for each antenna configuration of the determined set of configurations, the processor may predict data throughput to be obtained by performing communications with the antenna array and the power consumption associated with performing communications using the antenna array based on the obtained cell data for the second stage using a prediction model (e.g. a regression model).

In various examples, in particular, in which each antenna configuration of the determined set of configurations includes an antenna configuration in which only a subset of rows of the antenna array and/or only a subset of columns of the antenna array is to be used to perform communications, the processor may perform a plurality of predictions for each antenna configuration of the determined set of configurations, wherein each prediction of the plurality of predictions may include predicted performance metrics for an antenna configuration in which a subset of antenna elements of the respective antenna configuration is to be used to perform communications. Accordingly, while the first stage determination may obtain antenna configurations in which antenna elements are to be activated/deactivated based on a resolution associated with rows or columns (i.e. antenna configurations in which only a subset of rows or columns are to be used to perform communications), the second stage selection may obtain antenna configurations in which antenna elements of the previously determined subset of rows and columns are to be activated/deactivated with a resolution of antenna elements (i.e. antenna configurations in which only a subset of antenna elements of the respective subset of rows or columns are to be used to perform communications).

The processor may perform 907 a mapping operation based on each set of performance metrics predicted for the antenna configurations of the determined set of configurations to perform calculations. For example, the MNO may indicate preference of an objective for the calculations via the operator information. The objective may indicate how the performance metrics are related to the determination procedure 900 for the selection of the antenna configuration. In other words, the indicated objective may indicate a criterion (or criteria) to select the antenna configuration. Similar to the determination of the set of configurations, the MNO may indicate the objective by sending operator information representing a mathematical formula that is used to obtain a performance value based on parameters of the mathematical formula that are the predicted set of performance metrics for selecting the antenna configuration. Alternatively, or additionally, the MNO may send a mapping table that matches a plurality of predefined performance metrics of the set of performance metrics.

For this illustrative example, the operator information includes information representing a mathematical formula based on a first parameter associated with a predicted data throughput and a second parameter associated with a predicted power consumption. The processor may calculate a value using the mathematical formula for each set of predicted data throughput and predicted power consumption for each antenna configuration of the determined set of configurations using the mathematical formula. The operator information may also include information representing the criterion as the maximum calculated value is to be selected.

The processor may accordingly select 908 the antenna configuration based on the determined set of configurations according to the above-mentioned mapping operation. In this illustrative example, the processor may obtain multiple values for the multiple antenna configurations of the determined set of configurations, each value for each antenna configuration is obtained by performing a mapping operation according to the mathematical formula, that maps the respective predicted data throughput and the respective predicted power consumption for the respective antenna configuration to the respective value. The processor may then select 908 the antenna configuration having the highest obtained value, as indicated by the criterion, in order to select the antenna configuration.

FIG. 10 shows an exemplary illustration of antenna configurations according to the selection procedure 900. In this illustrative example, the processor may for an antenna array 1001, at the first stage in step 904, a set of configurations including a first antenna configuration 1011, a second antenna configuration 1012, and a third antenna configuration, in which a first selection of antenna elements corresponding to a subset of rows and columns of the antenna array 1001 are to be used to perform communications. Based on the determined set of configurations, the processor may perform a plurality of predictions for each of the first antenna configuration 1011, the second antenna configuration 1012, and the third antenna configuration 1013. Each prediction is for a further antenna configuration with a further selection of antenna elements of the selected antenna elements corresponding to the subset in the respective antenna configuration.

In this illustrative example, only further antenna configurations 1021, 1022 based on the second antenna configuration 1012 are shown for brevity. The processor may predict a first set of performance metrics for the second antenna configuration 1012 that includes only two of the antenna elements of the second antenna configuration 1012 (i.e. the first further antenna configuration 1021). The processor may also predict a second set of performance metrics for the second antenna configuration 1012 that includes all antenna elements of the second antenna configuration 1022 (i.e. the second further antenna configuration 1022). Based on the mapping operation, the processor selects, in this illustrative example, the first further antenna configuration as the selected antenna configuration 1031, and causes the antenna array to operate according to the selected antenna configuration 1031.

Referring back to FIG. 8, various aspects herein may utilize one or more artificial learning/machine learning models (AI/ML) model to determine a set of configurations and select an antenna configuration from the set of configurations in accordance with various aspects of this disclosure. The term “model” used herein may be understood as any kind of algorithm, which provides output data based on input data provided to the model (e.g., any kind of algorithm generating or calculating output data based on input data). In accordance with various aspects provided herein, the device 800 may use a first AI/ML to determine a set of configurations as provided in this disclosure, and may use a second AI/ML to select an antenna configuration from the determined set of configurations. Any reference associated with AI/ML may refer to both of the first AI/ML (i.e. AI/ML used to determine a set of configurations) and the second AI/ML (i.e. AI/ML used to select an antenna configuration from the determined set of configurations) in this disclosure, unless it is explicitly indicated.

The device 800 may implement the AI/ML. The device 800 may be a computing device or an apparatus suitable for implementing the AI/ML. The processor 801, or another processor as provided in this disclosure may implement the AI/ML. According to various aspects of this disclosure, other types of AI/ML implementations may include a further processor that may be internal or external to the processor (e.g. an accelerator, a graphics processing unit (GPU), a neuromorphic chip, etc.), or a memory may also implement the AI/ML. The AI/ML may be configured to provide output data based on input data and AI/ML parameters (model parameters). The AI/ML may include a trained AI/ML, in which the AI/ML parameters are configured according to a training process for the purpose of determining a set of configurations based on received input data for the first AI/ML, or selecting an antenna configuration from the determined set of configurations based on received input data for the second AI/ML.

A trained AI/ML may include an AI/ML which is trained prior to an inference to obtain output data. A trained AI/ML may further include an AI/ML which is trained based on the output data obtained via AI/ML (i.e. optimizations). In various aspects, AI/ML parameters include parameters configured to control how input data is transformed into output data. AI/ML parameters may further include hyperparameters configured to control how the AI/ML performs learning (e.g. learning rate, number of layers, classifiers, etc.).

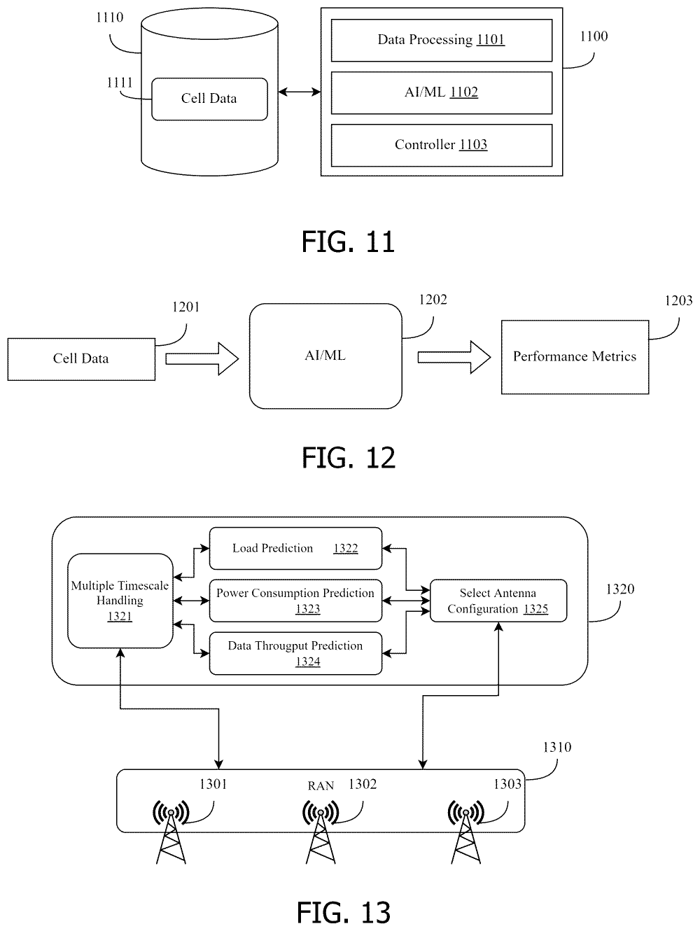

FIG. 11 shows an example of a processor and a memory of a device according to various aspects provided in this disclosure. The processor 1100 is depicted to include various functional units that are configured to provide various functions as disclosed herein, associated with a processor (e.g. the processor 801) that may be used within a device (e.g. the device 800). The skilled person would recognize that the depicted functional units are provided to explain various operations that the processor 1100 may be configured to perform. Similarly, the memory 1110 is depicted to include the cell data 1111 as a block, however, the memory may store the cell data 1111 in any kind of suitable configuration or mechanism. Furthermore, the AI/ML unit 1102 is depicted as it is implemented in the processor 1100 only as an example, and any type of AI/ML implementation which may include the implementation of the AI/ML in an external processor, such as an accelerator, a graphics processing unit (GPU), a neuromorphic chip, or in a cloud computing device, or in an external communication device may also be possible according to any methods.

The processor 1100 may include a data processing module 1101 that is configured to process data and obtain at least a portion of the cell data 1111 as provided in various examples in this disclosure to be stored in the memory 1110. In various examples, the cell data 1111 may include information for the past conditions of the cell for at least within a period of time in a plurality of instances of time (e.g. as a time-series data). The data processing module 1101 may obtain at least a portion of the cell data 1111 and the context information 1112 according to the operations of the device.

The AI/ML unit 1102 may implement an AI/ML, in particular, the first AI/ML used to determine a set of configurations and the second AI/ML used to select an antenna configuration from the set of configurations. The AI/ML may be configured to receive input data with certain constraints, features, and formats. Accordingly, the data processing module 1101 may obtain input data, that is based on the cell data 1111, to be provided to the first AI/ML and the second AI/ML respectively, to obtain an output of the AI/ML. In various examples, the data processing module 1101 may provide input data including the cell data 1111 to the AI/ML. The input data may include attributes of the cell data 1111 associated with a period of time or a plurality of consecutive periods of time. In various examples, the data processing module 1101 may convert the cell data 1111 to an input format suitable for the respective AI/ML (e.g. input feature vectors compatible with the first AI/ML and the second AI/ML respectively) so that the AI/ML may process the cell data 1111. The processor 1100 may further include a controller 1103 to control the AI/ML module 1102. The controller 1103 may provide the input data to the AI/ML, or provide the AI/ML module 1102 instructions to obtain the output. The controller 1103 may further be configured to perform further operations of the processor 1100 or the device associated with the processor in accordance with various aspects of this disclosure, such as encoding timescale information or causing the RRM model to be updated.

The AI/ML may be any type of machine learning model configured to receive the input data and provide an output as provided in this disclosure. The AI/ML may include any type of machine learning model suitable for the purpose. The AI/ML may include a decision tree model or a rule-based model suitable for various aspects provided herein. The AI/ML may include a neural network. The neural network may be any type of artificial neural network. The neural network may include any number of layers, including an input layer to receive the input data, an output layer to provide the output data. A number of layers may be provided between the input layer and the output layer (e.g. hidden layers). The training of the neural network (e.g., adapting the layers of the neural network, adjusting AI/ML parameters) may use or may be based on any kind of training principle, such as backpropagation (e.g., using the backpropagation algorithm).

For example, the neural network may be a feed-forward neural network in which the information is transferred from lower layers of the neural network close to the input to higher layers of the neural network close to the output. Each layer may include neurons that receive input from a previous layer and provide an output to a next layer based on certain AI/ML (e.g. weights) parameters adjusting the input information.

The AI/ML may include a recurrent neural network in which neurons transfer the information in a configuration in which the neurons may transfer the input information to a neuron of the same layer. Recurrent neural networks (RNNs) may help to identify patterns between a plurality of input sequences, and accordingly, RNNs may be used to identify, in particular, a temporal pattern provided with time-series data and perform estimations based on the identified temporal patterns. In various examples of RNNs, long short-term memory (LSTM) architecture may be implemented. The LSTM networks may be helpful to perform classifications, processing, and estimations using time series data.

An LSTM network may include a network of LSTM cells that may process the attributes provided for an instance of time as input data, such as attributes provided the instance of time, and one or more previous outputs of the LSTM that have taken in place in previous instances of time, and accordingly, obtain the output data. The number of the one or more previous inputs may be defined by a window size, and the weights associated with each previous input may be configured separately. The window size may be arranged according to the processing, memory, and time constraints and the input data. The LSTM network may process the features of the received raw data and determine a label for an attribute for each instance of time according to the features. The output data may include or represent a label associated with the input data.

In various examples, the neural network may be configured in top-down configuration in which a neuron of a layer provides output to a neuron of a lower layer, which may help to discriminate certain features of an input.

In accordance with various aspects, the AI/ML may include a reinforcement learning model. The reinforcement learning model may be modeled as a Markov decision process (MDP). The MDP may determine an action from an action set based on a previous observation which may be referred to as a state. In a next state, the MDP may determine a reward based on the current state that may be based on current observations and the previous observations associated with previous state. The determined action may influence the probability of the MDP to move into the next state. Accordingly, the MDP may obtain a function that maps the current state to an action to be determined with the purpose of maximizing the rewards. Accordingly, input data for a reinforcement learning model may include information representing a state, and an output data may include information representing an action.

The AI/ML may include a convolutional neural network (CNN), which is an example for feed-forward neural networks that may be used for the purpose of this disclosure, in which one or more of the hidden layers of the neural network include one or more convolutional layers that perform convolutions for their received input from a lower layer. The CNNs may be helpful for pattern recognition and classification operations. The CNN may further include pooling layers, fully connected layers, and normalization layers.

The AI/ML may include a generative neural network. The generative neural network may process input data in order to generate new sets, hence the output data may include new sets of data according to the purpose of the AI/ML. In various examples, the AI/ML may include a generative adversarial network (GAN) model in which a discrimination function is included with the generation function, and while the generation function may generate the data according to model parameters of the generation function and the input data, the discrimination function may distinguish the data generated by the generation function in terms of data distribution according to model parameters of the discrimination function. In accordance with various aspects of this disclosure, a GAN may include a deconvolutional neural network for the generation function and a CNN for the discrimination function.

The AI/ML may include a trained AI/ML that is configured to provide the output as provided in various examples in this disclosure based on the input data and one or more AI/ML parameters obtained by the training. The trained AI/ML may be obtained via an online and/or offline training. A training agent may perform various operations with respect to the training at various aspects, including online training, offline training, and optimizations based on the inference results. The AI/ML may take any suitable form or utilize any suitable technique for training process. For example, the AI/ML may be trained using supervised learning, semi-supervised learning, unsupervised learning, or reinforcement learning techniques.

In supervised learning, the AI/ML may be obtained using a training set of data including both inputs and corresponding desired outputs (illustratively, input data may be associated with a desired or expected output for that input data). Each training instance may include one or more input data item and a desired output. The training agent may train the AI/ML based on iterations through training instances and using an objective function to teach the AI/ML to estimate the output for new inputs (illustratively, for inputs not included in the training set). In semi-supervised learning, a portion of the inputs in the training set may be missing the respective desired outputs (e.g., one or more inputs may not be associated with any desired or expected output).

In unsupervised learning, the model may be built from a training set of data including only inputs and no desired outputs. The unsupervised model may be used to find structure in the data (e.g., grouping or clustering of data points), illustratively, by discovering patterns in the data. Techniques that may be implemented in an unsupervised learning model may include, e.g., self-organizing maps, nearest-neighbor mapping, k-means clustering, and singular value decomposition.

Reinforcement learning models may include positive feedback (also referred to as reward) or negative feedback to improve accuracy. A reinforcement learning model may attempt to maximize one or more objectives/rewards. Techniques that may be implemented in a reinforcement learning model may include, e.g., Q-learning, temporal difference (TD), and deep adversarial networks.

The training agent may adjust the AI/ML parameters of the respective model based on outputs and inputs (i.e. output data and input data). The training agent may train the AI/ML according to the desired outcome. The training agent may provide the training data to the AI/ML to train the AI/ML. In various examples, the processor and/or the AI/ML unit itself may include the training agent, or another entity that may be communicatively coupled to the processor may include the training agent and provide the training data to the device, so that the processor may train the AI/ML.

In various examples, the device may include the AI/ML in a configuration that it is already trained (e.g. the AI/ML parameters in a memory are already set for the purpose). It may desirable for the AI/ML itself to have the training agent, or a portion of the training agent, in order to perform optimizations according to the output of inferences as provided in this disclosure. The AI/ML may include an execution unit and a training unit that may implement the training agent as provided in this disclosure for other examples. In accordance with various examples, the training agent may train the AI/ML based on a simulated environment that is controlled by the training agent according to similar considerations and constraints of the deployment environment.

For example, the training input data for both the first AI/ML and the second AI/ML may include, or may be based on, training cell data generated or obtained to represent various states of a cell (or of a plurality of cells) as cell conditions. The training cell data may include information representative of one or more attributes designated to represent various conditions of a cell. Each training input data item may include cell data associated with conditions of a cell for an instance of a period of time. Training input data may further include training output data associated with the training input data representing desired outcomes concerning each set of training input data. For the first AI/ML, training output data may include a set of antenna configurations, and for the second AI/ML, training output data may include one antenna configuration. Training output data may indicate, or may represent, the desired outcome with respect to training input data, so that the training agent may provide necessary adjustments to respective AI/ML parameters in consideration of the desired outcome.

In other words, training cell data may include a plurality of data sets, in which each data set is representative of the conditions of a cell (conditions of the cell for a particular period of time/at a particular instance of time) and an output data associated with the conditions of the cell represented by the respective data set. The skilled person would immediately recognize that the exemplary AI/ML disclosed herein is explained that may have many configurations, but in implementation, the AI/ML is to be configured to receive input data based on designated attributes that are representative of the conditions of the cell and to provide output data including designated parameters. Accordingly, each data set of the training cell data for that particular AI/ML may include training inputs based on the same designated attributes that are representative of various conditions of a cell or various cells and the respective output data including the same designated attribute. In particular, considering an example associated with the determination of the set of configurations and the selection of an antenna configuration from the set of configurations may be based on cell data associated with different time period durations, the training input data for the first AI/ML and the training input data for the second AI/ML may represent conditions of the cell at different time period durations.

For example, for an AI/ML that is configured to receive input data based on attributes of user density within the cell, location of the cell, the topology of the cell and mobility of terminal devices within the cell within the cell data, and to provide output data that is representative of a determined set of configurations (i.e. the first AI/ML), each data set of the training cell data may include a training input data based on predefined attributes representative of a user density within a cell, a location for the cell, a topology associated with the location of the cell, a mobility of terminal devices within a cell, and a training output data representative of a determined set of configurations. By inferencing for each training input data, the training agent may adjust the AI/ML parameters of the AI/ML based on a predicted output by the AI/ML and the training output data based on an objective function. In various aspects provided herein, the objective function may be a mathematical function (i.e. a mapping operation that maps parameters to, for example, a value) based on performance metrics (i.e. predicted performance metrics and observed performance metrics) such as a loss function or a reward function.

For example, for an AI/ML that is configured to receive input data based on attributes of cell load of the cell, power consumption associated with the antenna array (e.g. power consumption of the respective network access node), data throughput obtained by communicating using the antenna array to select an antenna configuration from the determined set of configurations (i.e. the second AI/ML), each data set of the training cell data may include a training input data based on predefined attributes representative of a cell load of a cell, a predefined power consumption, a predefined data throughput, and a training output data representative of a selected antenna configuration. By inferencing for each training input data, the training agent may adjust the AI/ML parameters of the AI/ML based on a predicted output by the AI/ML and the training output data based on an objective function. In various aspects provided herein, the objective function may be a mathematical function (i.e. a mapping operation that maps parameters to, for example, a value) based on performance metrics (i.e. predicted performance metrics and observed performance metrics) such as a loss function or a reward function.

In other words, the training agent may train the AI/ML by providing training input data to the input of the AI/ML and it may adjust AI/ML parameters of the AI/ML based on the output of the AI/ML and training output data associated with the provided training input data with an intention to make the output of the AI/ML more accurate. Accordingly, the training agent may adjust one or more AI/ML parameters based on a calculation including parameters for the output of the AI/ML for the training input data and the training output data associated with the training input data. In various examples, the calculation may also include one or more parameters of the AI/ML. With each iteration with respect to the training input data that may include many data items, which each data item may represent an input of an instance (of time, of observation, etc.) on various aspects and each iteration may iterate a respective data item representing an input of an instance, the training agent may accordingly cause the AI/ML to provide more accurate output through adjustments made in the AI/ML parameters.

The processor 1100 may implement the training agent, or another entity that may be communicatively coupled to the processor 1100 may include the training agent and provide the training input data to the device, so that the processor 1100 may train the AI/ML. In various examples, the device may include the AI/ML in a configuration that it is already trained (e.g. the machine model parameters in the memory are set). It may desirable for the AI/ML itself to have the training agent, or a portion of the training agent, in order to perform optimizations according to the output of the inferences to be performed as provided in this disclosure. The AI/ML may include an execution unit and a training unit that may implement the training agent as provided in this disclosure for other examples.

Furthermore, the controller 1103 may control the AI/ML unit 1102 according to a predefined event. For example, the controller 1103 may provide instructions to the AI/ML unit 1102 to perform the AI/ML in response to a received request from another entity. Referring to aspects provided with respect to FIG. 7, the controller 1103 may instruct the AI/ML unit 1102 to perform the first AI/ML at t₁, and the controller 1103 may instruct the AI/ML unit 1102 to perform the second AI/ML at each t₁. The controller 1103 may further obtain output of the AI/ML from the AI/ML unit 1102 and cause the respective antenna array to operate based on the selected antenna configuration. In accordance with various aspects provided herein, the controller 1103 may determine the set of configurations and/or may select the antenna configuration based on the determined set of configurations based on the output of the AI/ML unit 1102 and further based on the operator information.

FIG. 12 shows an example of a trained AI/ML. The AI/ML 1202 may be configured to receive input data 1201 that is based on cell data and provide an output representative of a set of antenna configurations. In various examples, the input data 1201 may further include a feature representative of one or more antenna configuration candidates. In various examples, the input data 1201 may include information that is based on the cell data and the one or more antenna candidates that are transformed into a format that is suitable as input data for the AI/ML 1202, such as input feature vectors associated for attributes of the cell data and the one or more antenna configuration candidates.

For example, the cell data may include information representing user density of a cell for multiple past time instances (i.e. user density history), location of the antenna array or the location of the cell, and the terrain (topology) associated with the location of the antenna array, average mobility of terminal devices within the cell, as a time-series data. Accordingly, the input data 1201 may include, based on designated format of input data that the AI/ML 1202 is configured to receive, for example, input features as vectors, which each input feature vector is representative of the cell data for a particular instance of time. Furthermore, the input data may also include one antenna configuration candidate from the one or more antenna configuration candidates.

The one or more antenna configuration candidates may include predetermined antenna configurations quantized from possible configurations of the antenna array, that are based on row/column switch off (i.e. antenna configurations in which a subset of columns or a subset of rows are selected). A processor (e.g. the processor 1100) may assign an identifier (e.g. id number) for each predetermined antenna configuration. The assigned identifiers may be based on selection of the subset of columns or the subset of rows. The predetermined antenna configurations may be based on the antenna array information.

The AI/ML 1202 may be configured provide an output 1203 that is indicative or representative of one or more predicted performance metrics for the input antenna configuration (i.e. each output representative of one or more predicted performance metrics is for one predetermined antenna configuration). In an illustrative example, the output 1203 of the AI/ML 1202 may include a first performance metric that is representative of data throughput within the cell using the antenna array according to the respective predetermined antenna configuration, and a second performance metric that is representative of a power consumption associated with using the antenna array according to the respective predetermined antenna configuration (e.g. total power consumption of the respective entity including the antenna array, such as the network access node).

Accordingly, a processor (e.g. the processor 1100) may control an AI/ML unit (e.g. the AI/ML unit 1102) to obtain an output for each predetermined antenna configuration. The skilled person would recognize that the AI/ML 1202 may receive input representative of a plurality of predetermined antenna configurations, and provide an output representative of predicted performance metrics for each one of the plurality of predetermined antenna configurations in a single execution, for example as a multiple output predicter AI/ML.

Based on the plurality of predicted performance metrics for the plurality of update timescales, the processor may determine the set of configurations, by selecting a predetermined number of predetermined antenna configurations according to predicted performance metrics. The objective that may include a selection criteria may be stored in the memory. The operator information may indicate the selection criteria. In accordance with various aspects provided herein, the MNO may indicate preference of the objective for the calculations via the operator information.

The objective provided for this illustrative example may include information representative of a mathematical function that maps the first predicted performance metric and the second predicted metric for a predetermined antenna configuration to a value (e.g. a score), and may include a selection of a predetermined number (M) (e.g. M=10) of predetermined antenna configurations as the determined set of configurations, which have the highest mapped values. For example, an exemplary simple mathematical function may be Sᵢ=w₁*P_{1,i}−w₂*P_{2,i} where Sᵢ denotes the score of i-th predetermined antenna configuration, P_{1,i} denotes the first predicted performance metric for the i-th predetermined antenna configuration, P_{2,i} denotes the second predicted performance metric for the i-th predetermined antenna configuration, and w₁ and w₂ denote weights for the first predicted performance metric and the second predicted performance metric respectively. Accordingly, the processor may perform a mapping operation for each first predicted performance metric and second predicted performance metrics for each predetermined antenna configuration of the plurality of predetermined antenna configurations, and select M predetermined antenna configurations that have the highest mapped value as the determined set of configurations for the antenna array.

It can be seen that the AI/ML 1202 may have been trained with an objective function comprising a performance parameter associated with communication performance, and a power consumption parameter associated with power consumption. In the above-mentioned example, the objective function may include the performance parameter as the first predicted performance metric and the power consumption parameter as the second performance metric. During the training of the AI/ML 1202, the training agent (e.g. the processor) may use the data throughput information and power consumption information obtained by measuring conditions in which the antenna array is configured with that particular antenna configuration with the first predicted performance metric and the second predicted performance metric respectively (e.g. via a mean square loss function), for each inference, and adjust AI/ML parameters of the AI/ML 1202 based on actual information and predicted information. The processor may further optimize the AI/ML 1202 in a similar manner for each inference.

Accordingly, the processor may perform a mapping operation for each predetermined antenna configuration to map obtained performance metrics for the respective predetermined antenna configuration to a value to perform calculations. Based on the selection criterion (e.g. select M predetermined antenna configurations that return the highest values), the processor may determine the set of antenna configurations.

In accordance with various aspects provided herein, the objective information may further include information representing one or more thresholds for predicted performance metrics. Accordingly, the processor may determine the set of configurations based on the information representing one or more thresholds for predicted performance metrics, for example, by selecting predetermined antenna configurations for which performance metrics are predicted below or above the one or more thresholds.

The skilled person may recognize that as the number of possible predetermined antenna configurations that may be input to the AI/ML 1202 increases, the cost of training and optimization of the AI/ML 1202 may become expensive in terms of computation needs. Furthermore, the AI/ML 1202 may be configured to provide outputs that are different than the exact predicted power metrics that may match the objective function. The output of the AI/ML 1202 may, in various examples, include information representing the determined set of configurations. As AI/ML model parameters of the AI/ML 1202 may be configured with the training by finding parameters that maximize exemplarily the above-mentioned objective function. Considering the number of possible predetermined antenna configurations that may change with the size of the antenna array, the corresponding objective function to train and optimize the AI/ML 1202 may be challenging in terms of finding the gradient.

For this reason, the AI/ML 1202 may have been trained with the Bayesian optimization, and further, the processor may perform Bayesian optimization to optimize the AI/ML 1202. For this purpose, the training agent may have trained the AI/ML 1202 by providing inputs based on different antenna configurations, in which input data representative of different antenna configurations may include hyperparameters representative of different antenna configurations.

Hyperparameters may be considered as parameters that are input to an AI/ML (e.g. the AI/ML 1202) that a training (i.e. training, learning, optimizing) algorithm may use to learn optimal AI/ML parameters that may map the input features to an output that the AI/ML is configured to, with a desired accuracy. The outputs may include labels, targets, predictions, etc. The exact nature of hyperparameters may depend on the particular configuration of the AI/ML. For example, for an artificial neural network, the hyperparameters may include a number of hidden layers, a number of activation units in each layer, a selection of an activation function, kernel size, etc. The training agent may train the AI/ML using the hyperparameters by assigning arbitrary hyperparameters but that may extend the training required to obtain the desired accuracy. In accordance with various aspects provided herein, the training agent may train the AI/ML 1202 with arbitrary hyperparameters, or by finding hyperparameters using other methods, such as random search, grid search, etc.

Bayesian optimization may include a modeling operation to model the objective function (e.g. via a surrogate function) and an acquisition operation that may determine the next sample of hyperparameters, in particular, based on possible options to explore and possible options to exploit by predicting particular regions that may return better results. The modeling operation may initialize with an initial probability distribution over a function that is to be optimized. With each observation associated with the objective function, the training agent may perform an acquisition operation to select antenna configurations for exploration or exploitation, with an intention to optimize the objective function.

In accordance with various aspects provided herein, an AI/ML unit (e.g. the AI/ML unit 1102) may implement a second AI/ML that is similar to the AI/ML 1202 that may be configured to provide an output representing the selected antenna configuration. The second AI/ML may receive input data based on cell data of a further stage (i.e. cell data representing conditions of the cell for a different period of time after the period of time represented by the cell data that was provided into the AI/ML 1202). Furthermore, the input data of the second AI/ML may include the determined set of configurations. The second AI/ML may be configured to provide an output representing the selected antenna configuration by receiving the input data further including all the determined set of configurations, or the second AI/ML may be configured to receive input data further including an antenna configuration of the determined set of configurations, and the processor may provide such an input data to the second AI/ML for all configurations of the determined set of configurations. The processor may then select the antenna configuration based on outputs of the second AI/ML that are based on the determined set of configurations.

For example, the second AI/ML may predict performance metrics for each input antenna configuration of the determined set of configurations. Based on the predicted performance metrics, the processor may perform a mapping operation for each input antenna configuration of the determined set of configurations to map obtained performance metrics for the respective input antenna configuration to a value to perform calculations. Based on a selection criterion (e.g. select the antenna configuration that returns the highest value), the processor may select the antenna configuration from the determined set of antenna configurations.

In accordance with various aspects provided herein, the objective information of the second AI/ML may also include information representing one or more thresholds for predicted performance metrics. Accordingly, the processor may determine the set of configurations based on the information representing one or more thresholds for predicted performance metrics, for example, by selecting the input antenna configuration of the determined set of configurations for which performance metrics are predicted below or above the one or more thresholds.

FIG. 13 shows an example illustration of performance metric predictions, which a device (e.g. the device 800) may exemplarily implement for further stages. In this illustration, a radio access network 1310 is depicted to include a first network access node 1301, a second network access node 1302, and a third network access node 1302, each including an antenna array. The device 1320 (and accordingly various operations of the device 1321, 1322, 1323, 1324, 1325) is depicted in a manner that the device 1320 may communicate with the network access nodes 1301, 1302, 1303, or other devices within the radio access network 1310 to obtain cell data and to cause each of the network access nodes 1301, 1302, 1303 to operate with a selected antenna configuration.

In this illustrative example, the device 1320 may have already determined the set of configurations to be used by the network access nodes 1301, 1302, 1303 at an earlier stage based on cell data representative of conditions of respective cells associated with the network access nodes 1301, 1302, 1303. The network access nodes 1301, 1302, 1303 may serve the same cell, or different cells. For this illustrative example, the network access nodes 1301, 1302, 1303 may have been serving different cells, and the device 1320 may have determined the set of configurations, exemplarily using the AI/ML 1202, to be used by the network access nodes 1301, 1302, 1303 based on collective cell data representative of conditions of a plurality of cells.

For a further stage process including selecting an antenna configuration from the determined set of configurations, device 1320 may receive further cell data representative of the conditions of the cells. In this illustrative example, the cell data may include cell load of the respective cells, cell level QoS data (i.e. data throughput of the respective cells for communications performed with the respective antenna arrays and/or spectral efficiency (i.e. data throughput per spectral resources) for communication performed with the respective antenna arrays), and power consumption data representative of power consumption associated with the respective antenna arrays (e.g. total power consumption of respective network access nodes, estimated or measured power consumption of RF circuitry coupled to the respective antenna arrays, estimated or measured power consumption of antenna arrays, etc.).

Received cell data by the device 1320 provide information for respective attributes at different timescales. Accordingly, the processor of the device 1320 (e.g. data processing unit 1101) may handle different timescales to obtain cell data in a manner that the cell data has a designated timescale.

Furthermore, the processor of the device 1320 may predict performance metrics for each antenna configuration of the determined set of configurations based on the cell data in accordance with various examples provided herein. The processor may perform a load prediction 1322 based on the cell data, exemplarily based on the cell load of the respective cells, to obtain a predicted cell load metric for each antenna configuration. Similarly, the processor may perform a power consumption prediction 1323 based on the cell data, exemplarily based on received power consumption data associated with the respective antenna arrays, to obtain a predicted power consumption metric for each antenna configuration, and the processor may perform a data throughput prediction 1324 based on the cell data, exemplarily based on received cell level QoS data, to obtain a predicted data throughput metric for each antenna configuration.

The processor may map each set of predicted performance metrics for each antenna configuration of the determined set of antenna configurations into a score. The mapping operation may represent a predetermined mathematical formula, such as Sᵢ=w₁*P_{1,i}−w₂*P_{2,i}−w₃*P_{3,i} where Sᵢ denotes the score of i-th antenna configuration of the determined set of antenna configurations, P_{1,i} denotes the predicted data throughput metric for the i-th antenna configuration of the determined set of antenna configurations, P_{2,i} denotes the predicted power consumption metric for the i-th antenna configuration of the determined set of antenna configurations, P_{3,i} denotes the predicted cell load metric for the i-th antenna configuration of the determined set of antenna configurations, and w₁, w₂, and w₃ denote predetermined weights for the predicted metrics respectively. The processor may accordingly select the antenna configuration having the highest score. The processor may encode antenna configuration information representing the selected antenna configuration to the respective network access nodes 1301, 1302, 1303 to cause the antenna arrays of the respective network access nodes 1301, 1302, 1303 to operate according to the selected antenna configuration.

FIG. 14 shows an exemplary representation of a reinforcement learning model based AI/ML, that a processor (e.g. the processor 1100) may implement. In accordance with various aspects provided herein, a processor may implement an RL-based AI/ML that may provide an output representative of determined set of configurations, or that may provide an output representative of a selected antenna configuration from previously determined set of configurations. Within this context, a device (e.g. the device 800) may include a processor (e.g. the processor 1100) that may implement a first RL-based AI/ML model configured to receive input data based on cell data representative of cell conditions associated with a first instance of time and to provide an output representative of the determined set of configurations, and a second RL based AI/ML model configured to receive input data based on cell data representative of cell conditions associated with a second instance of time after the first instance of time and to provide an output representative of a selected antenna configuration from the determined set of configurations. The illustrated example is for further stage selections in accordance with various aspects provided herein.

A reinforcement learning agent (RL agent) 1401 (e.g. the AI/ML unit 1102) may determine an action based on a first observation (i.e. state) made for the observation environment and model parameters of the RL model, that may be the conditions of a cell 1402 served by a network access node 1405, represented for a first instance of time. In this illustrative example, input data provided to the respective AI/ML may be based on the cell data exemplarily including downlink/uplink PRB usage by the network access node 1405 via the antenna for which an antenna configuration is to be selected, number of terminal devices that are in RRC_Connected mode with the network access node 1405 over the respective antenna array, number of active terminal devices (e.g. that use radio resources over a predefined threshold) served by the respective antenna array, channel information for radio communication channels between the network access node 1405 and terminal devices (e.g. user channel quality summary provided by the network access node 1405), mobility of terminal devices connected to the network access node 1405 via the antenna array, time of the day, etc.

The RL agent 1401 may also obtain a first reward for the first instance of time with respect to a transition from a previous instance of time to the first instance of time, that may be represented by the first observation. For example, the RL agent 1401 may determine the action which may include a selection of an antenna configuration from the previously determined set of configurations for the antenna array 1404 that is used to communicate by the network access node 1405 within the cell 1402. A memory may store the previously determined set of configurations, that the device may have obtained, exemplarily via the AI/ML.

The RL agent 1401 may, based on the first observation, map the state represented with the first observation (i.e. the cell data at a first instance of time) to one of the antenna configurations of the determined set of configurations that maximizes the reward according to the estimation of the RL agent 1401 according to the model parameters of the RL model. Accordingly, the RL agent 1401 may output the selected antenna configuration to a controller 1403 (e.g. the controller 1103). The controller 1403 may cause the network access node 1405 to operate according to the selected antenna configuration by encoding antenna configuration information to be sent to the network access node 1405. Accordingly, the network access node 1405 may control the respective baseband processing circuitry, RF circuitry, and the antenna array to operate according to the selected antenna configuration. The network access node 1405 may accordingly disable/deactivate or operate in a lower power mode one or more components of the RF circuitry and the antenna array according to the selected antenna configuration, in which the network access node 1405 transmits and/or receives radio communication signals only with selected antenna elements of the selected antenna configuration. The operation of the network access node 1405 based on the selected antenna configuration may eventually move the state of the cell 1402 to a further state (i.e. due to communicating via activated/deactivated antenna elements of the antenna array according to the selected antenna configuration).

At a second instance of time, the RL agent 1401 may obtain a second reward with respect to the selected antenna configuration for the first instance of time for the transition from the first instance of time to the second instance of time with the selected antenna configuration. Based on the second reward, the RL agent 1401 may update the model parameters of the RL model to be used for a further selection of an antenna configuration, that may be based on a second observation at the second instance of time or a further instance of time. With each iteration for a new state and reward associated with the transition to the new state, the RL agent 1401 may learn or optimize the policy used to map the observations to the selection of the update timescale.

In one example, the reinforcement learning model may be based on Q-learning to provide the output in the particular state represented by the input according to a Q-function based on AI/ML parameters. The Q-function may be represented with an equation: Q_{new} (sₜ, aₜ)←(1−α)Q(sₜ, aₜ)+α(r+γ maxa(Q(sₜ₊ᵢ,a)) such that, s representing the state (observation) and a representing an antenna configuration, representing all state-action pairs (observation-antenna configuration pairs) with an index t, the new Q value of the corresponding state-action pair t is based on the old Q value for the state-action pair t and the sum of the reward r obtained by selecting the antenna configuration a t in the state s t with a discount rate γ that is between 0 and 1, in which the weight between the old Q value and the reward portion is determined by the learning rate α.

The discount factor may determine the importance of future rewards. A discount factor of 0 can make the agent “myopic” (or short-sighted) by only considering current rewards, while a factor close to 1 can make the agent strive for a long-term high reward. If the discount factor meets or exceeds 1, the action values may diverge, γ=1, all environment histories can become infinitely long, and utilities with additive, undiscounted rewards generally become infinite. Even with a discount factor only slightly lower than 1, Q-function learning leads to the propagation of errors and instabilities when the value function is approximated with an artificial neural network. In that case, starting with a lower discount factor and increasing the discount value towards a final value may accelerate the learning.

In relation with classification associated with selecting the antenna configuration using Q-learning the reward may be optimal data throughput and power consumption associated with the antenna array. One way of implementing Q-learning may include using Q-tables. The RL-agent 1401 may use a Q table with initial values as 0s or any other value. The states may include the cell data. During the training, Q table is updated with appropriate values. During the inferencing phase, selected antenna configurations are inferred from the Q-table.

In accordance with various aspects provided herein, observations may include information included in the cell data. In particular, any combination of attributes represented by the cell data, such as user density, location of the cell, load of the cell, mobility of terminal devices within the cell, interference patterns can be used as input. In any example associated with usage of an AI/ML, that may also include the RL, any type of information that may infer the conditions of the cell may be used, such as a number or size of used radio communication resources to communicate using the antenna array, a number of terminal devices served by the network access node with the antenna array, power consumption associated with the antenna array, a number of terminal devices having network traffic over a predefined threshold, communication channel information representative of attributes of the communication channel for each terminal device served by the network access node via the antenna array, time information representative of the period of time for each of the one or more attributes, channel information including at least one of channel quality information associated with the terminal devices, and reference signal strength indicators or reference signal received power measurements of respective established communication channels with the terminal devices, etc. Provided that the respective AI/ML is configured to provide an output based on received input data including such information, exemplarily trained using the corresponding training data and the structure of the respective AI/ML (e.g. layers, activation functions, etc.) are configured accordingly.

The RL agent 1401 may accordingly, based on an observation representative of cell conditions after selecting an antenna configuration for the antenna array, update expected rewards (e.g. update a reward function, or update Q-table) for learning. Furthermore, based on the observations representing the state, the RL agent 1401 may select the antenna configuration that maximizes the reward expected from the selected antenna configuration based on the reward function or Q-table.

In various examples, the rewards may be calculated based on the disclosed herein observations using the reward function. In accordance with various aspects, the RL agent 1401 may select the antenna configuration from the determined set of antenna configurations using Q-tables. Q-tables may include information representing an expected reward for each antenna configuration candidate that can be selected according to the state represented by the observations.

In various examples, the reward function or Q-table may include parameters based on predetermined performance metrics, such as cell throughput within the cell using the antenna array and power consumption associated with the antenna array. An exemplary reward function may be formulated as Rᵢ=w₁*P_{1,i}−w₂*P_{2,i} where Rᵢ denotes the reward of i-th transition from an instance of time to another instance of time, P_{1,i} denotes the first measured performance metric for the i-th transition, P_{2,i} denotes the second measured performance metric for the i-th transition, and w₁ and w₂ denote weights for the first performance metric and the second performance metric respectively. By arranging the respective weights, an optimum balance may be desired. In accordance with various aspects, the processor may set the respective weights based on operator information representative of the preference of MNO. Accordingly, in various examples, the observations associated with a transition from an instance of time to another instance of time may further include performance information representative of data throughput obtained within the cell using the antenna array according to the configuration of the antenna array with the previously selected antenna configuration, and power consumption information representative of power consumption associated with the antenna array obtained with the configuration of the antenna array with the previously selected antenna configuration.

In accordance with various aspects provided herein, a device (e.g. the device 800) may include the RL agent 1401 and the controller 1403, and the device 800 may further include the antenna array. The device further may also include the network access node 1405 including the antenna array. In various examples, the device may include the RL agent 1401 and the controller 1403, and may be communicatively coupled to a further entity may include the network access node 1402 and the antenna array.

In accordance with various aspects of this disclosure, the AI/ML may include a multi-armed bandit reinforcement learning model. In multi-armed bandit reinforcement learning models, the model may test available actions (e.g. a plurality of antenna configurations within the action set of the RL) at substantially equal frequencies. With each iteration, the AI/ML may adjust the machine learning model parameters to select actions that are leading better total rewards with higher frequencies at the expense of the remaining selectable actions, resulting in a gradual decrease with respect to the selection frequency of the remaining selectable actions, and possibly replace the actions that are gradually decreased with other selectable actions. In various examples, the multi-armed bandit RL model may select the actions irrespective of the information representing the state. The multi-armed RL model may also be referred as one-state RL, as it may be independent from the state.

Accordingly, with respect to examples provided in this section, the AI/ML may include a multi-armed bandit reinforcement learning model configured to select actions without any information indicating the state, in particular with an intention to explore rewards associated with the selection of an antenna configuration according to a state. It is to be recognized that the benefit obtained with arbitrary selection may have long-term benefit due to the learning of the associated outcome, but not for selecting the optimum antenna configuration. In order to obtain a balance between exploring (e.g. arbitrary selection) and exploitation (e.g. selecting antenna configuration that maximizes the reward according to current model parameters), the RL agent may be configured to perform an epsilon-greedy selection.

In accordance with various aspects provided herein, the AI/ML may include an RL model configured to perform an epsilon-greedy selection. The RL model may operate exemplarily as explained with respect to FIG. 14, with a difference in that the RL agent 1401 may select an antenna configuration from the determined set of configurations for exploration with a probability of E, and the RL agent 1401 may select an antenna configuration from the determined set of configurations for exploitation with a probability of 1-E that maximizes the reward. For this purpose, the processor may define E to the RL agent 1401. In various examples, E may be determined by the orchestrator entity of the mobile communication network within operator information.

The processor may generate a random number for each selection of an antenna configuration, and the RL agent 1401 may determine whether to select an antenna configuration for exploitation or to select an antenna configuration for exploration based on the generated random number and E. For example, the generated random number may be 0 and 1, and the RL agent 1401 may select an antenna configuration for exploration if the generated random number is equal or smaller than E. If the generated random number is greater than E, the RL agent 1401 may select an antenna configuration that maximizes the reward.

Furthermore, in consideration of a first stage of the antenna selection procedure, that is configured to determine a set of configurations, the set of actions available to the RL agent 1401 may be varying, as the outcome of multiple first stage iterations (for their respective period of time) may return different sets of configurations. The processor may manage the different sets of configurations that may be provided to the RL agent 1401 according to implementing methods for changing the action space of an RL-based AI/ML (i.e. dynamic action space).

In accordance with various examples provided herein, the respective RL-based AI/ML has been trained to have a set of actions and the RL agent may be configured to select an action from a set of valid actions of the set of actions. In this example in which the set of actions of the trained RL-based AI/ML may include all possible antenna configurations, the processor may provide information representative of the determined set of antenna configurations to the respective AI/ML unit, and the AI/ML unit may classify the set of actions, namely all possible antenna configurations, into a valid set of actions and invalid set of actions. In other words, the previously determined set of antenna configurations may correspond to a valid set of actions of the set of actions of the respective RL-based AI/ML, and other antenna configurations may correspond to invalid set of actions of the set of actions of the respective RL based AI/ML.

In another example, the RL-based AI/ML may be configured to apply action masks to filter actions of the action set. Accordingly, the AI/ML unit may obtain information representing the previously determined set of configurations from a memory and perform action masking by filtering antenna configurations that are not found in the determined set of configurations. Accordingly, the RL agent 1401 may only select an antenna configuration from the previously determined set of configurations.

FIG. 15 shows an exemplary illustration of various entities of a mobile communication network. It is to be noted that the exemplary illustration may indicate a logical structure, in which one or more of the entities of the mobile communication network 1500 may be implemented by the same physical entity, or a distributed physical entity (a plurality of devices operating collectively) may implement one of the entities of the mobile communication network 1500. The mobile communication network 1500 may include an orchestrator entity, a policy orchestration engine 1501 configured to oversee orchestration aspects, management aspects, and automation of RAN elements.

The policy orchestration engine 1501 may be configured to communicate with at least a dynamic antenna configuration selection entity 1502 that may include a device (e.g. the device 800) including a processor configured to select an antenna configuration for an antenna array, in accordance with various aspects provided in this disclosure. The dynamic antenna configuration selection entity 1502 may also communicate with a controller entity 1503 that may control configurations of a radio network 1504 including one or more network access nodes including one or more antenna arrays. For example, the controller entity 1503 may configure and/or control radio resources of the radio network 1504. In various examples, the controller entity 1503 may also operate within the radio network 1504, even in a network access node of the radio network 1504.

Within this exemplary mobile communication network 1500, an application of an entity may be configured to perform various aspects provided herein for the respective entity. Applications associated with different entities may communicate with each other via application programming interfaces (APIs) to receive and/or send data, information, messages, etc. In this illustrative example, the controller entity 1503 may identify a presence of an entity that is configured to select an antenna configuration based on cell conditions, namely the dynamic antenna configuration selection entity 1502, via an API designated to identify an entity that is configured to select an antenna configuration.

The controller entity 1503 may, optionally in response to the identification of the dynamic antenna configuration selection entity 1502, encode cell state information associated with one or more cells associated with one or more antenna arrays, for which the controller entity 1503 requests a dynamic antenna configuration selection service, send the encoded cell state information to the dynamic antenna configuration selection entity 1502. Accordingly, the dynamic antenna configuration selection entity 1502 may obtain cell data representative of conditions of the one or more cells based on received encoded cell state information. The controller entity 1503 may send the cell state information periodically, or in response to a request from the dynamic antenna configuration selection entity 1502, in order to update cell data for further instances or periods of time.

Alternatively, or additionally, the policy orchestration engine 1501, may send a request to the dynamic antenna configuration selection entity 1502 representative of a request of an antenna configuration selection for one or more antenna arrays within one or more cells. In response to receiving such a request, the dynamic antenna configuration selection entity 1502 may request cell state information for the designated one or more cells from the controller entity 1503, or from the respective radio access nodes of the radio network 1504. The controller entity 1503 may send encoded cell state information associated with the designated one or more cells to the dynamic antenna configuration selection entity 1502. Accordingly, the dynamic antenna configuration selection entity 1502 may obtain cell data representative of conditions of the designated one or more cells based on received encoded cell state information.

Furthermore, the dynamic antenna configuration selection entity 1502 may receive operator information from the policy orchestration engine 1501, and the operator information may represent preferences of an MNO, in particular configurations and commands provided by the policy orchestration engine 1501 to configure the selection of antenna configuration (i.e. antenna selection procedure). The operator information may represent various information as provided in this disclosure, exemplarily an identifier for each cell or a group of cells based on which conditions an antenna configuration is to be selected, an identifier for respective antenna arrays within those cells, for which an antenna configuration selection service is to be provided, one or more thresholds, limitations, or requirements for performance metrics (e.g. data throughput, power consumption, etc.), weights associated for performance metrics for selection of antenna configuration for the respective one or more antenna arrays (i.e. w₁ and w₂). The dynamic antenna configuration selection entity 1502 may receive the operator information via an API designated to receive policies from the policy orchestration engine 1501.

Furthermore, the dynamic antenna configuration selection entity 1502 may receive information from the controller entity 1503, and the received information may represent various attributes associated with the antenna array or the cell, in particular, used to configure the selection of an antenna configuration. The information may represent various information as provided in this disclosure, exemplarily a plurality of possible, or suggested antenna configurations, among which the dynamic antenna configuration selection entity 1502 may initially determine the set of antenna configurations from, capability, and requirements with respect to the respective antenna array or the respective cell such as minimum performance requirements, maximum compute overhead for inference and/or training for the respective AI/ML models to be operated, sample timescale or suggested timescales for the respective AI/ML models, weighting factors for the respective performance metrics for selecting an antenna configuration, an objective function used by respective AI/ML models, an objective function based on predefined performance metric parameters that may be a data throughput parameter and power consumption, other key performance indicators with respect to the conditions of the cell.

Accordingly, in accordance with various aspects provided in this disclosure, the dynamic antenna configuration selection entity 1502 may determine, at a first stage, a set of configurations based on conditions of the one or more cells associated with a first instance of time. Furthermore, the dynamic antenna configuration selection entity 1502 may select, at each further stage after the first stage, an antenna configuration for the respective one or more antenna arrays based on conditions of the one or more cells associated with a further instance of time after the first instance of time. For each further stage, the dynamic antenna configuration selection entity 1502 may send the selected antenna configuration to the controller entity 1503, and the controller entity 1503 may configure the respective one or more network access nodes to operate with the respective one or more antenna arrays using the selected antenna configuration

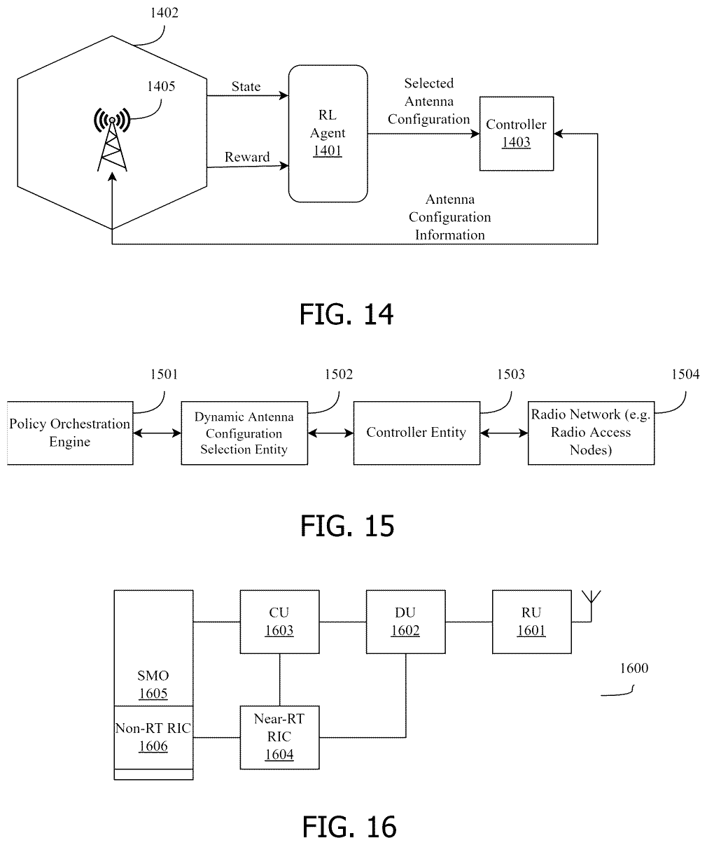

FIG. 16 shows an exemplary radio access network architecture in which the radio access network is disaggregated into multiple units. In LTE or 5G NR, network access nodes, such as a BS may implement the whole network stack including physical layer (PHY), media access control (MAC), radio link control (RLC), packet data convergence control (PDCP), and radio resource control (RRC) functions of the network stack. In a distributed approach of radio access networks, the processing of the network stack is disaggregated into at least two units (e.g. into RU, DU, and CU). Although the example illustrates a distributed structure that is based on open-RAN (O-RAN) architecture, the skilled person is able to populate the teaching provided herein in other types of distributed architectures, such as baseband unit (BBU) that may operate in the cloud and may be split to a Control Unit (CU) according to Re1.15 of 3GPP standards.

In various deployments in recently emerged RAN architectures, such as Open Radio Access Network (O-RAN) architectures, network access nodes may have functionalities that are split among multiple units with an intention to meet the demands of increased capacity requirements by providing a flexible and interoperable approach for RANs. The exemplary RAN 1600 provided herein includes a radio unit (RU) 1601, a distributed unit (DU) 1602, a central unit (CU) 1603, a near-RT RAN intelligent controller (near RT-RIC) 1604, and a service management and orchestration framework (SMO) 1605 including a non-RT RIC 1606. The skilled person would recognize that the illustrated structure may represent a logical architecture, in which one or more of the entities of the mobile communication network may be implemented by the same physical entity, or a distributed physical entity (a plurality of devices operating collectively) may implement one of the entities of the mobile communication network provided herein.

There are many approaches to provide the split among the multiple units. In this illustrative example, the CU 1603 (e.g. O-CU) may be mainly responsible for non-real time operations hosting the radio resource control (RRC), the PDCP protocol, and the service data adaptation protocol (SDAP). The DU (e.g. O-DU) 1602 may be mainly responsible for real-time operations hosting, for example, RLC layer functions, MAC layer functions, and Higher-PHY functions. RUs 1601 (e.g. O-RU) may be mainly responsible for hosting the Lower-PHY functions to transmit and receive radio communication signals to/from terminal devices (e.g. UEs) and provide data streams to the DU over a fronthaul interface (e.g. open fronthaul). The SMO 1605 may provide functions to manage domains such as RAN management, Core management, Transport management, and the non-RT RIC 1606 may provide functions to support intelligent RAN optimization via policy-based guidance, AI/ML model management, etc. The near-RT RIC 1604 may provide functions for real time optimizations, including hosting one or more xApps that may collect real-time information (per UE or per Cell) and provide services, that may include AI/ML services as well.

The exemplary RAN 1600 is illustrated for the purpose of brevity. The skilled person would recognize the aspects provided herein and may also realize that the exemplary RAN 1600 may include further characterizations, such as the CU may also be—at least logically-distributed into two entities (e.g. CU-Control Plane, CU-User Plane), there may be various types of interfaces between different entities of the exemplary RAN 1600 (e.g. E2, F1, O1, X2, NG-u, etc.).

In accordance with the exemplary distributed RAN architecture, a UE may transmit radio communication signals to the RU 1601 and receive radio communication signals from the RU 1601. The processing associated with the communication is performed at the respective layers of the network stack by respective entities that are responsible to perform the corresponding function of the respective layers.

In accordance with various aspects of this disclosure and this exemplary RAN 1600, aspects associated with the management of radio resources may include MAC layer functions within the DU 1602. Accordingly, the DU 1602 or the CU 1603 may include aspects of a controller entity provided herein.

In accordance with various aspects of this disclosure and this exemplary RAN 1600, aspects associated with network access nodes including an antenna array for which an antenna configuration is to be selected may be performed by functions of the RU 1601.

In accordance with various aspects of this disclosure and this exemplary RAN 1600, aspects associated with the selection of an antenna configuration (e.g. the device 800) may be performed by functions of the near RT-RIC 1604 or the non-RT RIC 1606. In a case that the aspects associated with the selection of an antenna configuration are implemented by the near-RT RIC 1604, the non-RT RIC 1604 may receive operator information from the SMO 1605, the near-RT RIC 1604 may exchange antenna array information and antenna configuration information with the CU 1603 or with the DU 1602. The near-RT RIC 1604 may receive cell state information from the DU 1602, the CU 1603, and/or even from the RU 1601 (the respective interface is not illustrated).

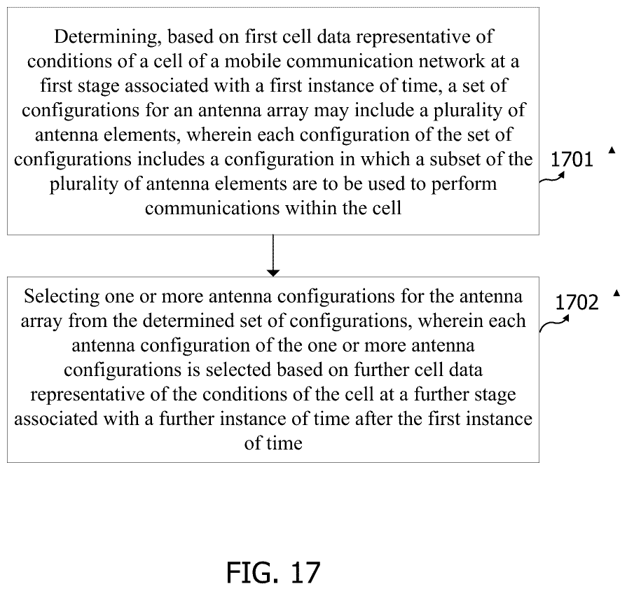

FIG. 17 shows an example of a method. The method that may include: determining 1701, based on first cell data representative of conditions of a cell of a mobile communication network at a first stage associated with a first instance of time, a set of configurations for an antenna array may include a plurality of antenna elements, wherein each configuration of the set of configurations includes a configuration in which a subset of the plurality of antenna elements are to be used to perform communications within the cell, selecting 1702 one or more antenna configurations for the antenna array from the determined set of configurations, wherein each antenna configuration of the one or more antenna configurations is selected based on further cell data representative of the conditions of the cell at a further stage associated with a further instance of time after the first instance of time.

The following examples pertain to further aspects of this disclosure.

In example 1, the subject matter includes a device that may include: a processor configured to: determine, based on first cell data representative of conditions of a cell of a mobile communication network at a first stage associated with a first instance of time, a set of configurations for an antenna array may include a plurality of antenna elements, wherein each configuration of the set of configurations includes a configuration in which a subset of the plurality of antenna elements are to be used to perform communications within the cell; select one or more antenna configurations for the antenna array from the determined set of configurations, wherein each antenna configuration of the one or more antenna configurations are selected based on further cell data representative of the conditions of the cell at a further stage associated with a further instance of time after the first instance of time.

In example 2, the subject matter of example 1, can optionally include that the processor is further configured to cause the antenna array to be configured with the selected one or more antenna configurations. In example 3, the subject matter of example 1 or example 2, can optionally include that the first cell data and the further cell data includes data representative of, for the respective instance of time, at least one of user density of the cell, location of the cell, topology associated with the location of the cell, load of the cell, mobility of mobile communication devices served by the cell, cross-interference between the cell and other interfering cells; estimated power consumption for the antenna array to transmit and receive radio communication signals within the cell; data throughput associated with the cell; and estimated spectral efficiency of the cell. In example 4, the subject matter of example 3, can optionally include that the first cell data and the further cell data further includes data representative of, for the respective instance of time, and each for a period of time associated with the respective instance of time, at least one of a number or size of used radio communication resources to communicate within the cell, a number of communication devices served by the cell, a number of communication devices having network traffic over a predefined threshold, communication channel information representative of attributes of the communication channel for each communication device served by the cell.

In example 5, the subject matter of any one of examples 1 to 4, can optionally include that the plurality of antenna elements are provided in a plurality of rows and a plurality of columns of the antenna array; can optionally include that each configuration of the determined set of configurations includes a configuration in which a subset of the plurality of rows and/or a subset of the plurality of columns are to be used to perform communications within the cell. In example 6, the subject matter of any one of examples 1 to 5, can optionally include that the processor is further configured to determine the set of configurations for a period of time may include a plurality of time intervals; can optionally include that each antenna configuration is selected for one of the plurality of time intervals. In example 7, the subject matter of any one of examples 1 to 6, can optionally include that the processor is configured to determine the set of configurations for the antenna array using a first trained machine learning model configured to receive input based on the first cell data and provide output representative of the determined set of configurations. In example 8, the subject matter of example 7, can optionally include that the first trained machine learning model is trained based on an objective function may include a performance parameter associated with communication performance within the cell and a power consumption parameter associated with consumption of power to transmit and receive radio communication signals via the antenna array.

In example 9, the subject matter of example 7 or example 8, can optionally include that hyperparameters of the first trained machine learning model is determined using a Bayesian optimization configured to arrange classifiers of the first trained machine learning model used to determine the set of configurations. In example 10, the subject matter of any one of examples 1 to 9, can optionally include that the processor is configured to predict one or more performance metrics associated with communication performance within the cell; can optionally include that the processor is configured to select each antenna configuration based on the predicted one or more performance metrics. In example 11, the subject matter of example 10, can optionally include that the one or more performance metrics are predicted based on the further cell data may include performance metric data representative of estimated performance metrics associated with the communication performance within the cell. In example 12, the subject matter of example 11, can optionally include that the one or more performance metrics includes metrics associated with at least one of a cell load of the cell, a power consumption to transmit and receive radio communication signals via the antenna array, and a data throughput within the cell. In example 13, the subject matter of example 12, can optionally include that the performance metric data includes data representative of at least one of past cell load of the cell, past power consumption to transmit and receive radio communication signals via the antenna array, and past data throughput within the cell.

In example 14, the subject matter of any one of examples 1 to 13, can optionally include that the processor is configured to select each antenna configuration based on further a mapping information that is configured to map one or more predefined power consumption parameters and one or more predefined data throughputs. In example 15, the subject matter of example 14, can optionally include that the mapping information is representative of a mathematical function that is configured to map the predicted metric associated with the power consumption to transmit and receive radio communication signals via the antenna array and the predicted metric associated with the data throughput within the cell to a value; can optionally include that the processor is configured to select each antenna configuration that maximizes or minimizes the value. In example 16, the subject matter of any one of examples 1 to 15, can optionally include that the processor is further configured to select each antenna configuration using a second trained machine learning model configured to receive input based on the further cell data and provide an output representative of the selected antenna configuration. In example 17, the subject matter of example 16, can optionally include that the second trained machine learning model includes a trained reinforcement learning model; can optionally include that the trained reinforcement learning model is configured to receive the input based on the respective further cell data as a state.

In example 18, the subject matter of example 17, can optionally include that the trained reinforcement learning model is configured to select an action from the set of actions based on the state; can optionally include that the set of actions includes the determined set of configurations. In example 19, the subject matter of example 18, can optionally include that the trained reinforcement learning model includes model parameters used to select an action from set of actions; can optionally include that the processor is configured to update the model parameters based on a calculated reward according an observation associated with the selected action; can optionally include that the observation includes performance information representative of a data throughput within the cell and power consumption associated with transmitting and receiving radio communication signals by the antenna array. In example 20, the subject matter of any one of examples 1 to 19, can optionally include that the processor is further configured to select each antenna configuration based on operator information representative of a preference of a mobile network operator (MNO); can optionally include that the operator information is representative of whether the MNO prefers a power saving configuration or a quality of service (QoS) based configuration. In example 21, the subject matter of example 20, can optionally include that the operator information is provided by an entity of the mobile communication network that is configured to orchestrate policies associated with management of the mobile communication network

In example 22, the subject matter of any one of examples 1 to 21, may further include a transceiver circuit coupled to the antenna array, can optionally include that the transceiver circuit includes components coupled to the plurality of antenna elements; can optionally include that the processor is configured to control the transceiver circuit to transmit and/or send radio communication signals using selected antenna elements of the plurality of antenna elements of the antenna array based on the selected antenna configuration. In example 23, the subject matter of example 22, may further include a controller configured to activate or deactivate the components coupled to the plurality of antenna elements of the antenna array based on the selected antenna configuration. In example 24, the subject matter of any one of examples 1 to 21, can optionally include that a further device that is external to the device is further configured to cause the antenna array to be configured with the selected antenna configuration; can optionally include that the processor is further configured to encode antenna configuration information representative of the selected antenna configuration for a transmission to the further device. In example 25, the subject matter of example 24, can optionally include that the mobile communication network includes an open radio access network (O-RAN); can optionally include that the further device includes a controller entity of the O-RAN, can optionally include that the controller entity includes a control unit (CU) or a distributed unit (DU); can optionally include that a radio unit (RU) includes the antenna array, the RU communicatively coupled to the CU and/or the DU.

In example 26, the subject matter of example 25, can optionally include that the processor is further configured to decode the first cell data and the further cell data received from the controller entity; can optionally include that the processor is further configured to encode the antenna configuration information for a transmission to the controller entity. In example 27, the subject matter of any one of examples 24 to 26; can optionally include that the device is implemented by a radio access network intelligent controller (RIC); can optionally include that the RIC is a near real time RIC or a non-real time RIC. In example 28, the subject matter of example 25, can optionally include that the antenna configuration information includes information that is configured to cause the RU to configure the antenna array based on the selected antenna configuration.

In example 29, the subject matter includes a method that may include: determining, based on first cell data representative of conditions of a cell of a mobile communication network at a first stage associated with a first instance of time, a set of configurations for an antenna array may include a plurality of antenna elements, wherein each configuration of the set of configurations includes a configuration in which a subset of the plurality of antenna elements are to be used to perform communications within the cell; selecting one or more antenna configurations for the antenna array from the determined set of configurations, wherein each antenna configuration of the one or more antenna configurations is selected based on further cell data representative of the conditions of the cell at a further stage associated with a further instance of time after the first instance of time.

In example 30, the subject matter of example 29, may further include: causing the antenna array to be configured with the selected one or more antenna configurations. In example 31, the subject matter of example 29 or example 30, can optionally include that the first cell data and the further cell data includes data representative of, for the respective instance of time, at least one of user density of the cell, location of the cell, topology associated with the location of the cell, load of the cell, mobility of mobile communication devices served by the cell, cross-interference between the cell and other interfering cells; estimated power consumption for the antenna array to transmit and receive radio communication signals within the cell; data throughput associated with the cell; and estimated spectral efficiency of the cell. In example 32, the subject matter of example 31, can optionally include that the first cell data and the further cell data further includes data representative of, for the respective instance of time, and each for a period of time associated with the respective instance of time, at least one of a number or size of used radio communication resources to communicate within the cell, a number of communication devices served by the cell, a number of communication devices having network traffic over a predefined threshold, communication channel information representative of attributes of the communication channel for each communication device served by the cell.

In example 33, the subject matter of any one of examples 29 to 32, can optionally include that the plurality of antenna elements are provided in a plurality of rows and a plurality of columns of the antenna array; can optionally include that each configuration of the determined set of configurations includes a configuration in which a subset of the plurality of rows and/or a subset of the plurality of columns are to be used to perform communications within the cell. In example 34, the subject matter of any one of examples 29 to 33, may further include: determining the set of configurations for a period of time may include a plurality of time intervals; can optionally include that each antenna configuration is selected for one of the plurality of time intervals. In example 35, the subject matter of any one of examples 29 to 34, may further include: determining the set of configurations for the antenna array using a first trained machine learning model configured to receive input based on the first cell data and provide output representative of the determined set of configurations. In example 36, the subject matter of example 35, can optionally include that the first trained machine learning model is trained based on an objective function may include a performance parameter associated with communication performance within the cell and a power consumption parameter associated with consumption of power to transmit and receive radio communication signals via the antenna array.

In example 37, the subject matter of example 35 or example 36, can optionally include that hyperparameters of the first trained machine learning model is determined using a Bayesian optimization configured to arrange classifiers of the first trained machine learning model used to determine the set of configurations. In example 38, the subject matter of any one of examples 29 to 37, may further include: predicting one or more performance metrics associated with communication performance within the cell; selecting each antenna configuration based on the predicted one or more performance metrics. In example 39, the subject matter of example 38, may further include: predicting the one or more performance metrics based on the further cell data may include performance metric data representative of estimated performance metrics associated with the communication performance within the cell. In example 40, the subject matter of example 39, can optionally include that the one or more performance metrics includes metrics associated with at least one of a cell load of the cell, a power consumption to transmit and receive radio communication signals via the antenna array, and a data throughput within the cell. In example 41, the subject matter of example 40, can optionally include that the performance metric data includes data representative of at least one of past cell load of the cell, past power consumption to transmit and receive radio communication signals via the antenna array, and past data throughput within the cell.

In example 42, the subject matter of any one of examples 29 to 41, may further include: selecting each antenna configuration based on further a mapping information that is configured to map one or more predefined power consumption parameters and one or more predefined data throughputs. In example 43, the subject matter of example 42, can optionally include that the mapping information is representative of a mathematical function that is configured to map the predicted metric associated with the power consumption to transmit and receive radio communication signals via the antenna array and the predicted metric associated with the data throughput within the cell to a value; can optionally include that the method further includes is selecting each antenna configuration that maximizes or minimizes the value. In example 44, the subject matter of any one of examples 28 to 43, may further include: selecting each antenna configuration using a second trained machine learning model configured to receive input based on the further cell data and provide an output representative of the selected antenna configuration.

In example 45, the subject matter of example 44, can optionally include that the second trained machine learning model includes a trained reinforcement learning model; can optionally include that the trained reinforcement learning model is configured to receive the input based on the respective further cell data as a state. In example 46, the subject matter of example 45, selecting an action from the set of actions based on the state using the trained reinforcement learning model; can optionally include that the set of actions includes the determined set of configurations. In example 47, the subject matter of example 46, can optionally include that the trained reinforcement learning model includes model parameters used to select an action from set of actions; can optionally include that the method further includes updating the model parameters based on a calculated reward according an observation associated with the selected action; can optionally include that the observation includes performance information representative of a data throughput within the cell and power consumption associated with transmitting and receiving radio communication signals by the antenna array.

In example 48, the subject matter of any one of examples 29 to 47, may further include: selecting each antenna configuration based on operator information representative of a preference of a mobile network operator (MNO); can optionally include that the operator information is representative of whether the MNO prefers a power saving configuration or a quality of service (QoS) based configuration. In example 49, the subject matter of example 48, can optionally include that the operator information is provided by an entity of the mobile communication network that is configured to orchestrate policies associated with management of the mobile communication network In example 50, the subject matter of any one of examples 29 to 49, may further include: controlling a transceiver circuit to transmit and/or send radio communication signals using selected antenna elements of the plurality of antenna elements of the antenna array based on the selected antenna configuration, can optionally include that the transceiver circuit coupled to the antenna array, can optionally include that the transceiver circuit includes components coupled to the plurality of antenna elements. In example 51, the subject matter of example 50, activating or deactivating the components, by a controller, coupled to the plurality of antenna elements of the antenna array based on the selected antenna configuration.

In example 52, the subject matter of any one of examples 29 to 50, may further include: encoding antenna configuration information representative of the selected antenna configuration for a transmission to a further device. can optionally include that the further device is external and configured to cause the antenna array to be configured with the selected antenna configuration. In example 53, the subject matter of example 52, can optionally include that the mobile communication network includes an open radio access network (O-RAN); can optionally include that the further device includes a controller entity of the O-RAN, can optionally include that the controller entity includes a control unit (CU) or a distributed unit (DU); can optionally include that a radio unit (RU) includes the antenna array, the RU communicatively coupled to the CU and/or the DU.

In example 54, the subject matter of example 53, may further include: decoding the first cell data and the further cell data received from the controller entity; encoding the antenna configuration information for a transmission to the controller entity. In example 55, the subject matter of any one of examples 52 to 54; can optionally include that the method is implemented by a radio access network intelligent controller (RIC); can optionally include that the RIC is a near real time RIC or a non-real time RIC. In example 56, the subject matter of example 55, can optionally include that the antenna configuration information includes information that is configured to cause the RU to configure the antenna array based on the selected antenna configuration.

In example 57, a non-transitory computer readable medium may include one or more instructions which, if executed by a processor, cause the processor to perform a method according to any one of examples 29 to 56.

In example 58, a device may include: a processor configured to: obtain cell data representative of conditions of a cell of a mobile communication network associated with a plurality of time instances; determine, for a period of time and based on the conditions associated with a first time instance of the plurality of time instances, a set of configurations for an antenna array may include a plurality of antenna elements, wherein each configuration of the set of configurations includes a configuration in which a subset of the plurality of antenna elements are to be used to perform communications within the cell; select, within the period of time, one or more antenna configurations from the determined set of configurations, wherein each antenna configuration is selected based on the conditions associated with one of the further time instances that are after the first time instance. In example 59, the device of example 58 can optionally include any aspects provided in this disclosure, in particular, aspects provided in examples 1 to 28.

The word “exemplary” is used herein to mean “serving as an example, instance, or illustration”. Any aspect or design described herein as “exemplary” is not necessarily to be construed as preferred or advantageous over other aspects or designs.

Throughout the drawings, it should be noted that like reference numbers are used to depict the same or similar elements, features, and structures, unless otherwise noted. It should be noted that certain components may be omitted for the sake of simplicity. It should be noted that nodes (dots) are provided to identify the circuit line intersections in the drawings including electronic circuit diagrams.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc.).

As used herein, a signal that is “indicative of” or “indicating” a value or other information may be a digital or analog signal that encodes or otherwise, communicates the value or other information in a manner that can be decoded by and/or cause a responsive action in a component receiving the signal. The signal may be stored or buffered in computer-readable storage medium prior to its receipt by the receiving component and the receiving component may retrieve the signal from the storage medium. Further, a “value” that is “indicative of” some quantity, state, or parameter may be physically embodied as a digital signal, an analog signal, or stored bits that encode or otherwise communicate the value.

As used herein, a signal may be transmitted or conducted through a signal chain in which the signal is processed to change characteristics such as phase, amplitude, frequency, and so on. The signal may be referred to as the same signal even as such characteristics are adapted. In general, so long as a signal continues to encode the same information, the signal may be considered as the same signal. For example, a transmit signal may be considered as referring to the transmit signal in baseband, intermediate, and radio frequencies.

The terms “processor” or “controller” as, for example, used herein may be understood as any kind of technological entity that allows handling of data. The data may be handled according to one or more specific functions executed by the processor or 9. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The terms “one or more processors” is intended to refer to a processor or a controller. The one or more processors may include one processor or a plurality of processors. The terms are simply used as an alternative to the “processor” or “controller”.

The term “user device” is intended to refer to a device of a user (e.g. occupant) that may be configured to provide information related to the user. The user device may exemplarily include a mobile phone, a smart phone, a wearable device (e.g. smart watch, smart wristband), a computer, etc.

As utilized herein, terms “module”, “component,” “system,” “circuit,” “element,” “slice,” “circuit,” and the like are intended to refer to a set of one or more electronic components, a computer-related entity, hardware, software (e.g., in execution), and/or firmware. For example, circuit or a similar term can be a processor, a process running on a processor, a controller, an object, an executable program, a storage device, and/or a computer with a processing device. By way of illustration, an application running on a server and the server can also be circuit. One or more circuits can reside within the same circuit, and circuit can be localized on one computer and/or distributed between two or more computers. A set of elements or a set of other circuits can be described herein, in which the term “set” can be interpreted as “one or more.”

As used herein, “memory” is understood as a computer-readable medium (e.g., a non-transitory computer-readable medium) in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, 3D Points, among others, or any combination thereof. Registers, shift registers, processor registers, data buffers, among others, are also embraced herein by the term memory. The term “software” refers to any type of executable instruction, including firmware.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art. The term “data item” may include data or a portion of data.

The term “antenna”, as used herein, may include any suitable configuration, structure and/or arrangement of one or more antenna elements, components, units, assemblies and/or arrays. The antenna may implement transmit and receive functionalities using separate transmit and receive antenna elements. The antenna may implement transmit and receive functionalities using common and/or integrated transmit/receive elements. The antenna may include, for example, a phased array antenna, a single element antenna, a set of switched beam antennas, and/or the like.

It will be understood that when an element is referred to as being “connected” or “coupled” to another element, it can be physically connected or coupled to the other element such that current and/or electromagnetic radiation (e.g., a signal) can flow along a conductive path formed by the elements. Intervening conductive, inductive, or capacitive elements may be present between the element and the other element when the elements are described as being coupled or connected to one another. Further, when coupled or connected to one another, one element may be capable of inducing a voltage or current flow or propagation of an electro-magnetic wave in the other element without physical contact or intervening components. Further, when a voltage, current, or signal is referred to as being “provided” to an element, the voltage, current, or signal may be conducted to the element by way of a physical connection or by way of capacitive, electro-magnetic, or inductive coupling that does not involve a physical connection.

Unless explicitly specified, the term “instance of time” refers to a time of a particular event or situation according to the context. The instance of time may refer to an instantaneous point in time, or to a period of time which the particular event or situation relates to.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), Spatial Divisional Multiple Access (SDMA), Time-Division Multiplexing (TDM), Time-Division Multiple Access (TDMA), Multi-User MIMO (MU-MIMO), General Packet Radio Service (GPRS), extended GPRS (EGPRS), Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth (BT), Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other aspects may be used in various other devices, systems and/or networks.

Some demonstrative aspects may be used in conjunction with a WLAN, e.g., a WiFi network. Other aspects may be used in conjunction with any other suitable wireless communication network, for example, a wireless area network, a “piconet”, a WPAN, a WVAN, and the like.

Some aspects may be used in conjunction with a wireless communication network communicating over a frequency band of 2.4 GHz, 5 GHz, and/or 6-7 GHz. However, other aspects may be implemented utilizing any other suitable wireless communication frequency bands, for example, an Extremely High Frequency (EHF) band (the millimeter wave (mmWave) frequency band), e.g., a frequency band within the frequency band of between 20 GHz and 300 GHz, a WLAN frequency band, a WPAN frequency band, and the like.

While the above descriptions and connected figures may depict electronic device components as separate elements, skilled persons will appreciate the various possibilities to combine or integrate discrete elements into a single element. Such may include combining two or more circuits to form a single circuit, mounting two or more circuits onto a common chip or chassis to form an integrated element, executing discrete software components on a common processor core, etc. Conversely, skilled persons will recognize the possibility to separate a single element into two or more discrete elements, such as splitting a single circuit into two or more separate circuits, separating a chip or chassis into discrete elements originally provided thereon, separating a software component into two or more sections and executing each on a separate processor core, etc.

It is appreciated that implementations of methods detailed herein are demonstrative in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method. All acronyms defined in the above description additionally hold in all claims included herein.

What is claimed is:

1. A device comprising:
a memory;
a processor configured to:
determine, based on first cell data representative of conditions of a cell of a mobile communication network at a first stage associated with a first instance of time, a set of configurations for an antenna array comprising a plurality of antenna elements, wherein each configuration of the set of configurations comprises a configuration in which a subset of the plurality of antenna elements are to be used to perform communications within the cell;
select one or more antenna configurations for the antenna array from the determined set of configurations, wherein each antenna configuration of the one or more antenna configurations are selected based on further cell data representative of the conditions of the cell at a further stage associated with a further instance of time after the first instance of time.

2. The device of claim 1,
wherein the processor is further configured to cause the antenna array to be configured with the selected one or more antenna configurations.

3. The device of claim 1,
wherein the first cell data and the further cell data comprises data representative of, for the respective instance of time, at least one of user density of the cell, location of the cell, topology associated with the location of the cell, load of the cell, mobility of mobile communication devices served by the cell, cross-interference between the cell and other interfering cells; estimated power consumption for the antenna array to transmit and receive radio communication signals within the cell; data throughput associated with the cell; and estimated spectral efficiency of the cell.

4. The device of claim 3,
wherein the first cell data and the further cell data further comprises data representative of, for the respective instance of time, and each for a period of time associated with the respective instance of time, at least one of a number or size of used radio communication resources to communicate within the cell, a number of communication devices served by the cell, a number of communication devices having network traffic over a predefined threshold, communication channel information representative of attributes of the communication channel for each communication device served by the cell.

5. The device of claim 1,
wherein the plurality of antenna elements are provided in a plurality of rows and a plurality of columns of the antenna array;
wherein each configuration of the determined set of configurations comprises a configuration in which a subset of the plurality of rows and/or a subset of the plurality of columns are to be used to perform communications within the cell.

6. The device of claim 1,
wherein the processor is further configured to determine the set of configurations for a period of time comprising a plurality of time intervals;
wherein each antenna configuration is selected for one of the plurality of time intervals.

7. The device of claim 1,
wherein the processor is configured to determine the set of configurations for the antenna array using a first trained machine learning model configured to receive input based on the first cell data and provide output representative of the determined set of configurations.

8. The device of claim 7,
wherein the first trained machine learning model is trained based on an objective function comprising a performance parameter associated with communication performance within the cell and a power consumption parameter associated with consumption of power to transmit and receive radio communication signals via the antenna array.

9. The device of claim 8,
wherein hyperparameters of the first trained machine learning model is determined using a Bayesian optimization.

10. The device of claim 1,
wherein the processor is configured to predict one or more performance metrics associated with communication performance within the cell;
wherein the processor is configured to select each antenna configuration based on the predicted one or more performance metrics.

11. The device of claim 10,
wherein the one or more performance metrics are predicted based on the further cell data comprising performance metric data representative of estimated performance metrics associated with the communication performance within the cell.

12. The device of claim 11,
wherein the one or more performance metrics comprises metrics associated with at least one of a cell load of the cell, a power consumption to transmit and receive radio communication signals via the antenna array, and a data throughput within the cell.

13. The device of claim 12,
wherein the performance metric data comprises data representative of at least one of past cell load of the cell, past power consumption to transmit and receive radio communication signals via the antenna array, and past data throughput within the cell.

14. The device of claim 1,
wherein the processor is configured to select each antenna configuration based on further a mapping information that is configured to map one or more predefined power consumption parameters and one or more predefined data throughputs.

15. The device of claim 14,
wherein the mapping information is representative of a mathematical function that is configured to map the predicted metric associated with the power consumption to transmit and receive radio communication signals via the antenna array and the predicted metric associated with the data throughput within the cell to a value;
wherein the processor is configured to select each antenna configuration that maximizes or minimizes the value.

16. The device of claim 1,
wherein the processor is further configured to select each antenna configuration using a second trained machine learning model configured to receive input based on the further cell data and provide an output representative of the selected antenna configuration.

17. The device of claim 16,
wherein the second trained machine learning model comprises a trained reinforcement learning model;
wherein the trained reinforcement learning model is configured to receive the input based on the respective further cell data as a state.

18. The device of claim 17,
wherein the trained reinforcement learning model is configured to select an action from the set of actions based on the state;
wherein the set of actions comprises the determined set of configurations.

19. The device of claim 18,
wherein the trained reinforcement learning model comprises model parameters used to select an action from set of actions;
wherein the processor is configured to update the model parameters based on a calculated reward according an observation associated with the selected action;
wherein the observation comprises performance information representative of a data throughput within the cell and power consumption associated with transmitting and receiving radio communication signals by the antenna array.

20. The device of claim 1,
further comprising a transceiver circuit coupled to the antenna array, wherein the transceiver circuit comprises components coupled to the plurality of antenna elements;
wherein the processor is configured to control the transceiver circuit to transmit and/or send radio communication signals using selected antenna elements of the plurality of antenna elements of the antenna array based on the selected antenna configuration.

21. The device of claim 1,
wherein a further device that is external to the device is further configured to cause the antenna array to be configured with the selected antenna configuration;
wherein the processor is further configured to encode antenna configuration information representative of the selected antenna configuration for a transmission to the further device.

22. The device of claim 21,
wherein the mobile communication network comprises an open radio access network (O-RAN);
wherein the further device comprises a controller entity of the O-RAN, wherein the controller entity comprises a control unit (CU) or a distributed unit (DU);
wherein a radio unit (RU) comprises the antenna array, the RU communicatively coupled to the CU and/or the DU.

23. The device of claim 22,
wherein the processor is further configured to decode the first cell data and the further cell data received from the controller entity;
wherein the processor is further configured to encode the antenna configuration information for a transmission to the controller entity;
wherein the device is implemented by a radio access network intelligent controller (RIC);
wherein the RIC is a near real time RIC or a non-real time RIC.

24. A non-transitory computer-readable medium comprising one or more instructions which, if executed by a processor, cause the processor to:
determine, based on first cell data representative of conditions of a cell of a mobile communication network at a first stage associated with a first instance of time, a set of configurations for an antenna array comprising a plurality of antenna elements, wherein each configuration of the set of configurations comprises a configuration in which a subset of the plurality of antenna elements are to be used to perform communications within the cell;
select one or more antenna configurations for the antenna array from the determined set of configurations, wherein each antenna configuration of the one or more antenna configurations are selected based on further cell data representative of the conditions of the cell at a further stage associated with a further instance of time after the first instance of time.

25. The non-transitory computer-readable medium of claim 24,
wherein the first cell data and the further cell data comprises data representative of, for the respective instance of time, at least one of user density of the cell, location of the cell, topology associated with the location of the cell, load of the cell, mobility of mobile communication devices served by the cell, cross-interference between the cell and other interfering cells; estimated power consumption for the antenna array to transmit and receive radio communication signals within the cell; data throughput associated with the cell; and estimated spectral efficiency of the cell.
